(19) United States
(12) Patent Application Publication
(10) Pub. No.: US 2026/0072367 A1
(43) Pub. Date: Mar. 12, 2026

(54) TONER

(71) Applicant: CANON KABUSHIKI KAISHA, Tokyo (JP)

(72) Inventors: KOKI INOUE, Shizuoka (JP); KENJI AOKI, Shizuoka (JP); SHUHEI IWASAKI, Kanagawa (JP); YUKI MASUDA, Shizuoka (JP)

(21) Appl. No.: 19/309,295

(22) Filed: Aug. 25, 2025

(30) Foreign Application Priority Data
Sep. 9, 2024 (JP) 2024-154655

(51) Int. Cl. G03G 9/087; G03G 9/08

(52) U.S. Cl. CPC G03G 9/08711; G03G 9/0821

(57) ABSTRACT

A toner comprising a toner particle comprising a resin component, wherein the resin component comprises a crystalline vinyl resin, in differential scanning calorimetric measurement of the toner, in a heating process 1 in which a temperature is raised from 20° C. to 180° C. at a ramp rate of 10° C./min, there is one endothermic peak P1 derived from the crystalline vinyl resin, and following the heating process 1, in a heating process 2 in which a temperature is lowered from 180° C. to 20° C. at a ramp down rate of 10° C./min, and a temperature is raised again from 20° C. to 180° C. at a ramp rate of 10° C./min, there are two endothermic peaks P21 and P22 derived from the crystalline vinyl resin, an endothermic quantities of the endothermic peak P1, P21 and P22 satisfy a specific relationship.

### BACKGROUND

### Field of the Technology

The present disclosure relates to a toner.

### Description of the Related Art

Conventionally, energy saving has been considered as a major technical issue in electrophotographic devices, and ways of significantly reducing the amount of heat applied to fixing devices are being investigated. There is an increasing need for toners that can be fixed with low energy, so-called “low-temperature fixability.”

As a method enabling low-temperature fixation, a method using a crystalline resin as a binder resin is being investigated. An amorphous resin that is generally used as a toner binder resin does not exhibit a clear endothermic peak in differential scanning calorimeter (DSC) measurement, but if the toner comprises a crystalline resin component, an endothermic peak (melting point) appears in DSC measurement.

Crystalline resins have regularly arranged molecular chains and thus have a property of minimal softening at temperatures lower than the melting point. In addition, when the melting point is exceeded, crystals rapidly melt, and accordingly, a rapid viscosity decrease is caused. Crystalline resins having an excellent sharp melt property in this manner are being focused on as materials useful for improving low-temperature fixability of the toner.

Toners using a crystalline vinyl resin having long-chain alkyl groups in the side chains in the molecule as a crystalline resin may be exemplified. Generally, crystalline vinyl resins have a structure in which long-chain alkyl groups are bonded to the main chain as side chains, the long-chain alkyl groups in the side chains crystallize with each other to form a lamella structure in which the molecules are regularly arranged, and thereby crystalline resins are formed.

When such a structure is formed, the molecules are easily loosened, which is an advantageous property for low-temperature fixation, and on the other hand, there is a property of being susceptible to brittle fracture when subjected to impact.

Brittle fracture can be broadly classified into cleavage fracture occurring along a specific crystal plane inside of crystal grains and grain boundary fracture occurring along crystal grain boundaries. Cracks formed due to impact tend to spread in a limited direction that is parallel to the lamella structure in the case of cleavage fracture and in the direction of the crystal interface in the case of grain boundary fracture. Particularly, in toners that comprise large amounts of crystalline resins, the crystal planes and crystal interfaces elongate in a specific direction, and thus extension of cracks occurs significantly.

For this reason, in toners that comprise large amounts of the crystalline resins, streaks and cracks that occur when a fixed image is bent tend to spread, and the bending resistance may be insufficient.

Japanese Patent Publication No. 2014-106464 discloses a toner that can exhibit excellent low-temperature fixability by using a crystalline resin and maximizing the compatibility of a crystalline resin with an amorphous resin after fixing. In the toner disclosed in Japanese Patent Publication No. 2014-106464, since the compatibility between the crystalline resin and the amorphous resin is very high, the degree of crystallinity of the crystalline resin on the fixed image is very low. In such a toner, the fixed image does not exhibit a cleavage property of the crystalline resin, resulting in favorable bending resistance of the fixed image, which is an issue with toners using a crystalline resin.

On the other hand, the above toners easily cause images to become sticky in a high temperature and high humidity environment due to their low degree of crystallinity. Therefore, it can be understood that, when printed paper sheets are stacked and left, the paper sheets adhere to each other, and when peeled off, defects are likely to occur in the image, and an image loading property may be insufficient.

Japanese Patent Publication No. 2022-163694 discloses a toner that achieves both low-temperature fixability and bending resistance by a means of adding an amorphous vinyl resin having a different polymerizable monomer ratio to a crystalline vinyl resin. With such a toner, since the crystalline state is maintained in the fixed image, the image loading property is improved. Nevertheless, it can be understood that, due to the presence of a large amount of amorphous moieties and insufficient control of the crystalline state, there is an issue with the image loading property in a high temperature and high humidity environment or in recent high-speed printing processes.

Japanese Patent Publication No. 2021-140029 discloses a toner that can achieve both bending resistance and the image loading property by using two types of crystalline resins in combination and improving the durability of the fixed image against an external force.

However, in the toner disclosed in Japanese Patent Publication No. 2021-140029, when two types of crystalline resins are used, there are two endothermic peaks having different melting points. When there are two endothermic peaks, the viscosity decreases gradually as the temperature increases from the low-temperature side endothermic peak to the high-temperature side endothermic peak. Therefore, it can be understood that the sharp melt property and low-temperature fixability, which are characteristics of toners using the crystalline resin, tend to deteriorate.

### SUMMARY

At least one aspect of the present disclosure is to provide a toner which achieves the low-temperature fixability, bending resistance and image loading property together and has excellent scratch resistance.

At least one aspect of the present disclosure is to provide a toner comprising a toner particle comprising a resin component,
wherein the resin component comprises a crystalline vinyl resin,
when a temperature indicating a minimum value on a differential curve of a DSC endothermic curve during heating in differential scanning calorimetric measurement of the toner is defined as a peak top temperature,
in a heating process 1 in which a temperature is raised from 20° C. to 180° C. at a ramp rate of 10° C./min, there is one endothermic peak derived from the crystalline vinyl resin, and
following the heating process 1, in a heating process 2 in which a temperature is lowered from 180° C. to 20° C. at a ramp down rate of 10° C./min, and a temperature is raised again from 20° C. to 180° C. at a ramp rate of 10° C./min, there are two endothermic peaks derived from the crystalline vinyl resin,
when the endothermic peak derived from the crystalline vinyl resin in the heating process 1 is defined as an endothermic peak P1,
in the heating process 2, between the two endothermic peaks derived from the crystalline vinyl resin, a low-temperature side endothermic peak exhibiting the peak top temperature is defined as an endothermic peak P21, a high-temperature side endothermic peak exhibiting the peak top temperature is defined as an endothermic peak P22,
an endothermic quantity of the endothermic peak P1 is defined as S1 (J/g), an endothermic quantity of the endothermic peak P21 is defined as S21 (J/g), and an endothermic quantity of the endothermic peak P22 is defined as S22 (J/g),
the S1, the S21 and the S22 satisfy following Formulas (1) to (3):

S1≥(S21+S22)≥S1×0.25 Formula (1)

S21≥S1×0.10 Formula(2)

S22≥S1×0.10 Formula (3)

According to at least one aspect of the present disclosure, it is possible to provide a toner which achieves the low-temperature fixability, the bending resistance and the image loading property together and has excellent scratch resistance.

Features of the present disclosure will become apparent from the following description of embodiments. The following description of embodiments is described by way of example.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In addition, in the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ.

The (meth)acrylic acid ester means an acrylic acid ester and/or a methacrylic acid ester.

The “monomer unit” refers to the reacted form of a monomer substance in a polymer. For example, one carbon-carbon bond section in the main chain in the polymer in which the polymerizable monomer has been polymerized is defined as one unit. The polymerizable monomer can be represented by the following formula (C).

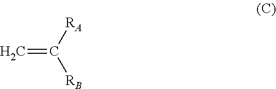

In the formula (C), R_{A} represents a hydrogen atom or an alkyl group (preferably an alkyl group having from 1 to 3 carbon atoms, and more preferably a methyl group), and R_{B} represents an arbitrary substituent.

The “crystalline resin” is a resin that exhibits a clear endothermic peak in differential scanning calorimeter (DSC) measurement. The “endothermic peak” is a peak that is characterized by a minimum value on a differential curve of a DSC endothermic curve during heating in differential scanning calorimetric measurement.

The inventors have found that the above problem can be solved by appropriately controlling the crystalline state of the crystalline vinyl resin in the toner on the fixed image, that is, by appropriately controlling the number of endothermic peaks and the endothermic quantity in the DSC endothermic curve during each heating process when the toner undergoes different heating processes in differential scanning calorimetric measurement.

The toner according to the present disclosure is a toner comprising a toner particle comprising a resin component,
wherein the resin component comprises a crystalline vinyl resin,
when a temperature indicating a minimum value on a differential curve of a DSC endothermic curve during heating in differential scanning calorimetric measurement of the toner is defined as a peak top temperature,
in a heating process 1 in which a temperature is raised from 20° C. to 180° C. at a ramp rate of 10° C./min, there is one endothermic peak derived from the crystalline vinyl resin, and
following the heating process 1, in a heating process 2 in which a temperature is lowered from 180° C. to 20° C. at a ramp down rate of 10° C./min, and a temperature is raised again from 20° C. to 180° C. at a ramp rate of 10° C./min, there are two endothermic peaks derived from the crystalline vinyl resin,
when the endothermic peak derived from the crystalline vinyl resin in the heating process 1 is defined as an endothermic peak P1,
in the heating process 2, between the two endothermic peaks derived from the crystalline vinyl resin, a low-temperature side endothermic peak exhibiting the peak top temperature is defined as an endothermic peak P21, a high-temperature side endothermic peak exhibiting the peak top temperature is defined as an endothermic peak P22,
an endothermic quantity of the endothermic peak P1 is defined as S1 (J/g), an endothermic quantity of the endothermic peak P21 is defined as S21 (J/g), and an endothermic quantity of the endothermic peak P22 is defined as S22 (J/g),
the S1, the S21 and the S22 satisfy following Formulas (1) to (3):

S1≥(S21+S22)≥S1×0.25 Formula (1)

S21≥S1×0.10 Formula (2)

S22≥S1×0.10 Formula (3)

The toner according to the present disclosure is a toner comprising a toner particle comprising a resin component, and the resin component comprises a crystalline vinyl resin.

The temperature indicating a minimum value on a differential curve of a DSC endothermic curve during heating in differential scanning calorimetric measurement of the toner is defined as a peak top temperature. In addition, in differential scanning calorimetric measurement of the toner, a process in which a temperature is raised from 20° C. to 180° C. at a ramp rate of 10° C./min is defined as a heating process 1. In this case, in the heating process 1, there is one endothermic peak derived from the crystalline vinyl resin.

In the heating process 1, when there is one endothermic peak derived from the crystalline vinyl resin, the heat resistance is favorable at a temperature lower than the melting point, and a sharp melt property of the crystalline resin, in which crystals rapidly melt when the melting point is exceeded, is exhibited. As a result, low-temperature fixability of the toner is improved.

On the other hand, in the heating process 1, when there are two or more endothermic peaks, the viscosity of the toner decreases gradually as the temperature increases during fixing from the low-temperature side endothermic peak to the high-temperature side endothermic peak, and the sharp melt property deteriorates. As a result, the low-temperature fixability is likely to decrease.

In order to control the number of endothermic peaks to be one in the heating process 1, for example, there is a method in which, when two or more types of crystalline vinyl resins are used, the types and addition amounts of the crystalline vinyl resins used are appropriately selected, and thus the affinity between the crystalline vinyl resins is controlled and a eutectic state is easily formed. In addition, it can also be controlled by adjusting the cooling rate and the annealing retention temperature and time after cooling in a toner particle producing step. A specific example of a method of controlling the number of endothermic peaks to be one will be described below.

In the differential scanning calorimetric measurement, following the heating process 1, a process in which a temperature is lowered from 180° C. to 20° C. at a ramp down rate of 10° C./min, and a temperature is raised again from 20° C. to 180° C. at a ramp rate of 10° C./min is defined as a heating process 2. In this case, in the heating process 2, there are two endothermic peaks derived from the crystalline vinyl resins.

In the heating process 2, the presence of two endothermic peaks derived from the crystalline vinyl resins indicates that two types of crystalline states are mixed in the toner.

The endothermic peak derived from the crystalline vinyl resin in the heating process 1 is P1. In addition, in the heating process 2, between two endothermic peaks derived from the crystalline vinyl resins, the low-temperature side endothermic peak is defined as an endothermic peak P21, and the high-temperature side endothermic peak is defined as an endothermic peak P22. That is, the endothermic peak P21 is an endothermic peak having a low-temperature side peak top temperature, and the endothermic peak P22 is an endothermic peak having a high-temperature side peak top temperature.

When an endothermic quantity of the endothermic peak P1 is defined as S1 (J/g), an endothermic quantity of the endothermic peak P21 is defined as S21 (J/g), and an endothermic quantity of the endothermic peak P22 is defined as S22 (J/g), the S1, the S21 and the S22 satisfy following Formula (1).

S1≥(S21+S22)≥S1×0.25 Formula (1)

As shown in Formula (1), the endothermic quantity (S21+S22) in the heating process 2 is equal to or less than the endothermic quantity (S1) in the heating process 1. This suggests that the amount of crystals and the crystal diameter in each peak in the heating process 2 are smaller than those in the heating process 1.

To summarize the above, when the condition that there are two endothermic peaks derived from the crystalline vinyl resins in the heating process 2 and the endothermic quantity (S21+S22) in the heating process 2 is equal to or less than the endothermic quantity (S1) in the heating process 1 is satisfied, it is thought that two types of crystalline states with small crystal diameters are mixed in the toner on the fixed image.

When the toner on the fixed image is in this state, the directions of crystal planes and crystal interfaces are not limited. Thus, even if a crack occurs inside of the crystal or at the crystal interface, the progressing crack immediately reaches a crystal plane or crystal interface in a different extension direction. Since the crack does not progress through a crystal plane or crystal interface in a different extension direction, the progress of the crack is likely to stop in such a toner. This deteriorates the cleavage property of the resin component in the toner, and as a result, the bending resistance of the fixed image is improved.

When there is no endothermic peak in the heating process 2, the crystalline state in the toner is not sufficiently controlled and images tend to become sticky in a high temperature and high humidity environment. In addition, the heat resistance to frictional heat generated when the fixed image is rubbed decreases, and the image density is likely to decrease when the image is rubbed. That is, the scratch resistance is likely to decrease.

On the other hand, when there is one endothermic peak in the heating process 2 and the endothermic quantity is sufficient to improve the image loading property, there are no mixed crystalline states in the toner on the fixed image and there are large crystals having the same structure. In this case, the crack becomes longer in the extension direction on the crystal plane or at the crystal interface, and when a crack occurs, it tends to lead to a large fracture. Therefore, the bending resistance is likely to decrease.

In addition, when there are three or more endothermic peaks in the heating process 2, the area of the crystal interface increases excessively as the degree of crystallinity increases. Because the crystal interface is one factor that affects the cleavage property of the crystalline resin, an excessive increase in the area of the crystal interface tends to decrease the bending resistance. In addition, it is difficult to control the number of endothermic peaks to be one in the heating process 1, and the low-temperature fixability is likely to decrease as the sharp melt property deteriorates.

In order to control the number of endothermic peaks to be two in the heating process 2, for example, there is a method in which, when two or more types of crystalline vinyl resins are used, the monomer units used in the crystalline vinyl resins are appropriately selected.

Since the endothermic peak in the heating process 2 indicates the melting point of the crystalline vinyl resin, when the carbon chain length of the monomer units of two or more types of crystalline vinyl resins and the molecular weight of the crystalline vinyl resins are adjusted, the melting point of each crystalline vinyl resin can be controlled, and the number of peaks can be controlled to be two. A specific example of a method of controlling the number of endothermic peaks to be two will be described below.

In addition, by a method of controlling the affinity between the crystalline vinyl resin and other materials such as a wax, the number of endothermic peaks in the heating process 2 can be controlled to be two. Since each crystalline vinyl resin has different affinity with other materials, by simply using this difference, the melting point of a specific crystalline vinyl resin can be changed, and the number of endothermic peaks can be controlled to be two.

As shown in Formula (1), the total amount (S21+S22) of the endothermic quantities of the endothermic peaks derived from the crystalline vinyl resins in the heating process 2 is 25% or more of the endothermic quantity (S1) of the endothermic peak derived from the crystalline vinyl resin in the heating process 1.

Satisfying the above range indicates that the degree of crystallinity of the crystalline resin in the toner on the fixed image is sufficient. Therefore, the image is less likely to become sticky after fixing, and the image loading property of the fixed image is improved.

In order to further improve the image loading property, the total amount of the endothermic quantities of the endothermic peaks derived from the crystalline vinyl resins in the heating process 2 is more preferably 30% or more and still more preferably 45% or more of the endothermic quantity of the endothermic peak derived from the crystalline vinyl resin in the heating process 1. That is, it is more preferable to satisfy (S21+S22)≥S1×0.30, and it is still more preferable to satisfy (S21+S22)≥S1×0.45.

As described above, the total amount (S21+S22) of the endothermic quantities of the endothermic peaks derived from the crystalline vinyl resins in the heating process 2 is equal to or less than the endothermic quantity S1 of the endothermic peak derived from the crystalline vinyl resin in the heating process 1. The upper limit of (S21+S22) is not particularly limited as long as it satisfies the above range, and is, for example, preferably 95% or less and more preferably 90% or less of S1. That is, it is preferable to satisfy S1×0.95≥(S21+S22), and it is more preferable to satisfy S1×0.90≥(S21+S22).

In addition, the toner satisfies the condition that each endothermic quantity of two endothermic peaks derived from the crystalline vinyl resins in the heating process 2 is 10.0% or more of the endothermic quantity of the endothermic peak derived from the crystalline vinyl resin in the heating process 1. That is, the toner satisfies following Formula (2) and following Formula (3).

S21≥S1×0.10 Formula (2)

S22≥S1×0.10 Formula (3)

When the toner satisfies Formulae (2) and (3), the degree of crystallinity becomes sufficient in the crystalline state that exhibits each endothermic peak. As a result, the image loading property of the fixed image is improved.

In order to further improve the image loading property, the endothermic quantity of each peak derived from the crystalline vinyl resin in the heating process 2 is preferably 15.0% or more and more preferably 25.0% or more of the endothermic quantity of the endothermic peak derived from the crystalline vinyl resin in the heating process 1. That is, it is preferable to satisfy S21≥S1×0.15 and satisfy S22≥S1×0.15. In addition, it is more preferable to satisfy S21≥S1×0.25 and satisfy S22≥S1×0.25.

The upper limit of the endothermic quantity of each peak derived from the crystalline vinyl resin in the heating process 2 is not particularly limited as long as it satisfies the above range, and is, for example, preferably 80.0% or less, more preferably 70.0% or less, and still more preferably 60.0% or less of the endothermic quantity of the endothermic peak derived from the crystalline vinyl resin in the heating process 1.

For example, it is preferable to satisfy S1×0.80≥S21, more preferable to satisfy S1×0.70≥S21, and still more preferable to satisfy S1×0.60≥S21. In addition, it is preferable to satisfy S1×0.80≥S22, more preferable to satisfy S1×0.70≥S22, and still more preferable to satisfy S1×0.60≥S22.

S1 is preferably from 10.0 to 30.0 (J/g) because the bending resistance can be reduced while the sharp melt property of the crystalline resin is exhibited. S1 is more preferably from 13.0 to 27.0 (J/g), and still more preferably from 20.0 to 25.0 (J/g).

In addition, in order to achieve a high level of both the bending resistance and the image loading property, S21 is preferably from 2.0 to 13.0 (J/g), more preferably from 5.0 to 10.0 (J/g), and still more preferably from 7.3 to 9.2 (J/g). For the same reason, S22 is preferably from 2.0 to 10.0 (J/g), more preferably from 3.0 to 7.0 (J/g), and still more preferably from 4.2 to 5.3 (J/g). For the same reason, S21+S22 is preferably from 5.0 to 20.0 (J/g), more preferably from 7.0 to 17.0 (J/g), and still more preferably from 11.5 to 14.5 (J/g).

In order to control the endothermic quantity at each endothermic peak so that Formula (1) to Formula (3) are all satisfied, for example, there is a method of appropriately controlling the types of crystalline vinyl resins used, the addition amounts of materials other than the binder resin, such as a wax, and the ramp down rate and the annealing retention temperature and time after cooling in the toner particle producing step. Specifically, the following means may be exemplified.

As a means for increasing S1, for example, in a toner production method to be described below, the degree of crystallinity of the crystalline vinyl resin may be decreased by increasing the ramp down rate after the polymerization is completed and performing annealing after cooling for a short time.

As a means for decreasing S1, for example, the degree of crystallinity of the crystalline vinyl resin may be increased by decreasing the ramp down rate and performing the annealing for a long time.

Specific conditions for the ramp down rate after the polymerization is completed and the annealing step will be described below.

As a means for increasing S21, for example, in the crystalline vinyl resin associated with the low-temperature side endothermic peak, by increasing the polarity of the crystalline vinyl resin other than the long-chain alkyl moieties, the long-chain alkyl moieties are likely to aggregate, and thus the degree of crystallinity may increase.

As a means for decreasing S21, for example, in the crystalline vinyl resin associated with the low-temperature side endothermic peak, by decreasing the polarity of the crystalline vinyl resin other than the long-chain alkyl moieties, the long-chain alkyl moieties are unlikely to aggregate, and thus the degree of crystallinity may decrease.

As a means for increasing S22, for example, in the crystalline vinyl resin associated with the high-temperature side endothermic peak, the amount of the wax added, which functions as a nucleating agent for crystallization, may be increased.

As a means for decreasing S22, for example, in the crystalline vinyl resin associated with the high-temperature side endothermic peak, the amount of the wax added, which functions as a nucleating agent for crystallization, may be decreased.

A preferable range of the amount of the wax added will be described below.

As a means for increasing S21+S22, the above means for increasing S21 and S22 may be appropriately combined.

As a means for decreasing S21+S22, the above means for decreasing S21 and S22 may be appropriately combined.

When the peak top temperature of the endothermic peak P1 is T1 (° C.), T1 is preferably from 50.0 to 80.0° C.

When T1 is 50.0° C. or higher, a rapid decrease in the viscosity of the toner can be reduced in a high temperature and high humidity storage environment, and heat-resistant storability is further improved. T1 is more preferably 53.0° C. or higher, and still more preferably 55.0° C. or higher.

In addition, when T1 is 80.0° C. or lower, since the viscosity of the toner decreases even if the temperature of the fixing unit is low, low-temperature fixability becomes better. In order to make it easier to further improve low-temperature fixability, T1 is more preferably 65.0° C. or lower and still more preferably 62.0° C. or lower.

That is, when T1 is within the above range, it is possible to obtain a toner that achieves both heat-resistant storability and low-temperature fixability. T1 is more preferably from 53.0 to 70.0° C., still more preferably from 55.0 to 65.0° C., and yet more preferably from 55.0 to 62.0° C.

Examples of methods of controlling the peak top temperature T1 to be within the above range include appropriately selecting the alkyl chain length of the monomer units used in the crystalline vinyl resin and controlling the molecular weight of the crystalline vinyl resin.

When the peak top temperature of the endothermic peak P21 is T21 (° C.), T21 is preferably 45.0° C. or higher. T21 is more preferably 50.0° C. or higher and still more preferably 55.0° C. or higher.

When T21 is 45.0° C. or higher, the heat resistance to frictional heat generated when the fixed image is rubbed is further improved. Therefore, a decrease in image density before and after rubbing of the image can be reduced, and the scratch resistance is further improved. In addition, when the difference between T22 and T21 (T22−T21) to be described below is within a specific range, the scratch resistance can be further improved.

The upper limit of T21 is not particularly limited, and generally 85.0° C. or lower. That is, T21 is preferably from 45.0 to 85.0° C., more preferably from 50.0 to 85.0° C., and still more preferably from 55.0 to 85.0° C.

Examples of methods of controlling the peak top temperature T21 to be within the above range include appropriately selecting the alkyl chain length of the monomer units used in the crystalline vinyl resin and controlling the molecular weight of the crystalline vinyl resin.

When the peak top temperature of the endothermic peak P21 is T21 (° C.), and the peak top temperature of the endothermic peak P22 is T22 (° C.), T21 and T22 preferably satisfy following Formula (4).

20.0≥(T22−T21)≥3.0 Formula (4)

The difference between T22 and T21 (T22−T21) being 3.0° C. or higher indicates that crystals in two different crystalline states in the resin component are sufficiently separated. That is, this indicates that the crystalline vinyl resin can be prevented from becoming partially eutectic and the formation of large crystal aggregates can be curbed. In such a case, cleavage can be reduced and the bending resistance is further improved. The value of (T22−T21) is more preferably 3.5 or more and still more preferably 4.0 or more.

In addition, when the difference between T22 and T21 is 20.0° C. or lower, it is easy to curb the formation of an excessive eutectic state between a high-melting-point material such as a wax and a crystalline vinyl resin. Therefore, the melting point of the high-melting-point material can be kept high, the heat resistance to frictional heat generated when the fixed image is rubbed is further improved, and thus the scratch resistance is further improved. The value of (T22−T21) is more preferably 15.0 or less and still more preferably 10.0 or less.

Examples of methods of controlling the relationship between T22 and T21 to satisfy Formula (4) include appropriately selecting the alkyl chain length of the monomer units used in the crystalline vinyl resin and controlling the molecular weight of the crystalline vinyl resin.

The toner particle comprises a resin component. The resin component comprises a crystalline vinyl resin. The resin component may comprise a crystalline vinyl resin A, a crystalline vinyl resin B, an amorphous polyester resin C and a styrene acrylic resin. The resin component may be a binder resin. The resin component is, for example, a resin other than a wax.

Hereinafter, crystalline vinyl resins will be described.

The content of the crystalline vinyl resin in the resin component comprised in the toner particle is preferably from 30.0 to 60.0 mass %. The content is more preferably from 33.0 to 55.0 mass %, and still more preferably from 35.0 to 50.0 mass %.

When the resin component comprises 30.0 mass % or more of the crystalline vinyl resin, since the toner comprises a sufficient amount of crystalline components, the sharp melt property of the crystalline resin is significantly exhibited. Therefore, the low-temperature fixability is improved.

In addition, when the content of the crystalline vinyl resin in the resin component is 60.0 mass % or less, since the toner does not comprise an excessive amount of crystalline components, cleavage of the crystalline resin is reduced, and the bending resistance is further improved. That is, when the content of the crystalline vinyl resin in the resin component is within the above range, it is possible to achieve both excellent low-temperature fixability and bending resistance.

The crystalline vinyl resin preferably comprises a monomer unit (a) represented by the following Formula (5).

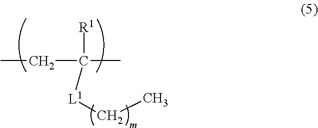

In Formula (5), R¹ represents a hydrogen atom or a methyl group, Li represents a single bond, an ester bond or an amide bond, and m represents an integer of 15 to 30.

That is, the monomer unit (a) of the crystalline vinyl resin has a long-chain alkyl group (alkyl group having 16 to 31 carbon atoms) as a side chain of the crystalline vinyl resin which is a vinyl polymer. As a result, the crystalline vinyl resin has crystallinity, and a toner having excellent low-temperature fixability and heat-resistant storability is obtained.

When vinyl polymerization is performed using a (meth)acrylic acid ester having an alkyl group having 16 to 31 carbon atoms as a polymerizable monomer, the monomer unit (a) can be incorporated as a monomer unit of the crystalline vinyl resin. As a result, a crystalline vinyl resin having the monomer unit (a) represented by Formula (5) can be obtained.

Examples of methods for introducing a crystalline vinyl resin into the monomer unit (a) include a method of polymerizing (meth)acrylic acid ester as follows.

Examples thereof include (meth)acrylic acid esters having an alkyl group having 16 to 31 carbon atoms [cetyl (meth)acrylate, stearyl (meth)acrylate, nonadecyl (meth)acrylate, eicosyl (meth)acrylate, heneicosyl (meth)acrylate, behenyl (meth)acrylate, lignoceryl (meth)acrylate, ceryl (meth)acrylate, octacosyl (meth)acrylate, myristyl (meth)acrylate, and so forth].

Among these, in consideration of low-temperature fixability and heat-resistant storability of the toner, the monomer unit (a) is preferably at least one selected from the group consisting of (meth)acrylic acid esters having a linear alkyl group having 16 to 31 carbon atoms, more preferably at least one selected from the group consisting of (meth)acrylic acid esters having an alkyl group having 18 to 30 carbon atoms, and still more preferably at least one selected from the group consisting of linear stearyl (meth)acrylates and behenyl (meth)acrylates.

That is, in Formula (1), the number of carbon atoms (m) is preferably an integer of 15 to 29, more preferably an integer of 17 to 29, and still more preferably an integer of 17 or 21. In addition, R¹ is preferably a hydrogen atom.

The crystalline vinyl resin may have only one type of the monomer unit (a) or two or more types thereof.

The content of the monomer unit (a) in the crystalline vinyl resin is preferably 40.0 to 100.0 mass % in order to obtain excellent low-temperature fixability and bending resistance. The content is more preferably 50.0 to 100.0 mass %, and still more preferably 60.0 to 100.0 mass %.

Here, the content of the monomer unit (a) in the crystalline vinyl resin indicates a total content of the monomer unit (a) represented by Formula (1) in the crystalline vinyl resin, and when the crystalline vinyl resin comprises two or more types of monomer units (a), the content indicates a total content of all the monomer units (a).

The crystalline vinyl resin preferably comprises a crystalline vinyl resin A in which the content of the monomer unit (a) is from 50.0 to 70.0 mass % and a crystalline vinyl resin B in which the content of the monomer unit (a) is from 80.0 to 100.0 mass %.

When a combination of two types of crystalline vinyl resins A and B having different contents of the monomer unit (a) is used, in differential scanning calorimetric measurement of the toner, a phenomenon (peak splitting) in which the number of endothermic peaks increases from one to two from the heating process 1 to the heating process 2 is more likely to occur. That is, when a combination of the crystalline vinyl resin A and the crystalline vinyl resin B is used, it is easier to obtain the toner according to the present disclosure.

When the difference between the content of the monomer unit (a) in the crystalline vinyl resin A and the content of the monomer unit (a) in the crystalline vinyl resin B is 50.0 mass % or less, the molecular structures of two types of crystalline vinyl resins become similar, which enables them to exhibit reasonably similar crystallization behavior. Therefore, it becomes easier to perform control such that there is one endothermic peak in the heating process 1. In addition, when cooling and annealing conditions are adjusted, the endothermic peak in the heating process 1 can be controlled more precisely. Specific conditions for the cooling step and the annealing step will be described below.

In addition, when the difference between the content of the monomer unit (a) in the crystalline vinyl resin A and the content of the monomer unit (a) in the crystalline vinyl resin B is 10.0 mass % or more, a sufficient difference is created, and two types of crystalline vinyl resins having appropriately different crystallization behaviors are present in the crystalline vinyl resin. As a result, it is easier to perform control such that there are two endothermic peaks in the heating process 2.

In addition, it is easier to adjust the endothermic peak in the heating process 2 more precisely by adjusting cooling and annealing conditions and using a material such as a wax that can be in a eutectic state. Specific conditions for the cooling step and the annealing step will be described below.

The content of the monomer unit (a) in the crystalline vinyl resin A is more preferably 53.0 to 67.0 mass % and still more preferably 55.0 to 65.0 mass %. In addition, the content of the monomer unit (a) in the crystalline vinyl resin B is more preferably 85.0 to 100.0 mass % and still more preferably 90.0 to 100.0 mass %.

As the combination of two types of crystalline vinyl resins, it is more preferable to comprise a crystalline vinyl resin A in which the content of the monomer unit (a) is 55.0 to 65.0 mass % and a crystalline vinyl resin B in which the mass proportion of the monomer unit (a) is 90.0 to 100.0 mass %.

According to the above combination, the difference in the content of the monomer unit (a) between the crystalline vinyl resin A and the crystalline vinyl resin B is 25.0 to 45.0 mass %, and the peak splitting effect can be obtained more significantly. As a result, it is easier to obtain a toner exhibiting one endothermic peak derived from the crystalline vinyl resin in the heating process 1 and two endothermic peaks derived from the crystalline vinyl resins in the heating process 2, and the low-temperature fixability and particularly excellent bending resistance can be achieved.

In addition to the monomer unit (a), the crystalline vinyl resin may comprise other monomer units. Examples of methods for introducing other monomer units into the crystalline vinyl resin include a method of polymerizing the (meth)acrylic acid ester with other vinyl monomers.

Examples of other vinyl monomers include the following:
(Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having 3 to 22 carbon atoms [primary amines (n-butylamine, t-butylamine, propylamine, isopropylamine, and so forth), secondary amines (di-n-ethylamine, di-n-propylamine, di-n-butylamine, and so forth), aniline, cycloxylamine, and so forth] with an isocyanate having 2 to 30 carbon atoms and an ethylenically unsaturated bond by a known method.

Monomers having a carboxy group; for example, methacrylic acid, acrylic acid, and 2-carboxyethyl (meth)acrylate.

Monomers having a hydroxy group; for example, 2-hydroxyethyl (meth)acrylate, 2-hydroxypropyl (meth)acrylate, and so forth

Monomers having an amide group; for example, acrylamide, and monomers obtained by reacting an amine having 1 to 30 carbon atoms with a carboxylic acid having 2 to 30 carbon atoms and having an ethylenically unsaturated bond (acrylic acid, methacrylic acid, and so forth) by a known method.

Monomers having a lactam structure; for example, N-vinyl-2-pyrrolidone.

Among these, monomers having a lactam structure are preferable, and particularly, N-vinyl-2-pyrrolidone having a 5-membered lactam structure is more preferable. That is, the crystalline vinyl resin preferably comprises monomer units having a lactam structure. The monomer unit having a lactam structure is preferably represented by the following Formula (L) (more preferably Formula (L-1)).

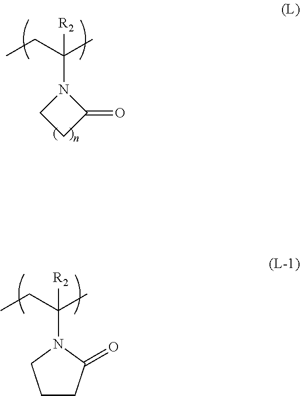

In Formula (L) and Formula (L-1), R₂ represents a hydrogen atom or a methyl group.

The crystalline vinyl resin more preferably comprises monomer units having a 5-membered lactam structure. The crystalline vinyl resin still more preferably comprises a monomer unit corresponding to N-vinyl-2-pyrrolidone.

When the resin comprises monomer units having a 5-membered lactam structure, a weak hydrogen bond is formed between the pyrrolidonyl group in the lactam structure and the carboxylic acid in the crystal resin. Since the bond is weak, it does not adversely affect fixability, but a force that appropriately connects the interfaces of the crystal aggregates together is generated.

As described above, the toner according to the present disclosure is characterized by small crystal aggregates, but the total interfacial area increases as the diameter of crystal aggregates decreases, which may affect interfacial brittleness. When the crystalline vinyl resin comprises monomer units having a 5-membered lactam structure, it is possible to reduce the influence of interfacial brittleness while maintaining low-temperature fixability. As a result, it is easier to achieve the low-temperature fixability and better bending resistance and image loading property and scratch resistance together.

The content of the monomer units having a lactam structure in the crystalline vinyl resin is preferably 2.0 to 15.0 mass %.

In the crystalline vinyl resin, the weight-average molecular weight (Mw) of a tetrahydrofuran (THF)-soluble component measured by gel permeation chromatography (GPC) is preferably from 30,000 to 200,000.

When the Mw of the crystalline vinyl resin is within the above range, it is easier to adjust the peak top temperature T1 of the endothermic peak P1 to be within an appropriate range. In addition, since a property of separation from the wax becomes appropriate, it is easier to achieve both the low-temperature fixability and heat-resistant storability.

The Mw range of the crystalline vinyl resin is more preferably from 40,000 to 180,000, and still more preferably from 60,000 to 150,000.

The toner may comprise an amorphous resin as a resin component other than the crystalline vinyl resin.

Examples of amorphous resins include a vinyl resin, a polyester resin, a polyurethane resin, and an epoxy resin, and a vinyl resin and a polyester resin are preferable.

When the amorphous resin is a vinyl resin, for example, vinyl monomers that can be used in the crystalline vinyl resin can be used. The (meth)acrylic acid ester used for introducing the monomer unit (a) can also be used in a range in which the amorphous resin does not exhibit crystallinity.

In addition, so-called crosslinking agents having a plurality of vinyl groups per monomer can also be used. Examples of crosslinking agents include the following:

Diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene, divinyl ether, 4,4′-divinylbiphenyl, and the like.

When a polyester resin is used as the amorphous resin, a polyester resin that can be obtained by reacting a divalent or higher valency carboxylic acid with a polyhydric alcohol can be used.

Examples of polyvalent carboxylic acids include the following:
Dibasic acids such as succinic acid, adipic acid, sebacic acid, phthalic acid, isophthalic acid, terephthalic acid, malonic acid, and dodecenyl succinic acid, anhydrides thereof or lower alkyl esters thereof, and aliphatic unsaturated dicarboxylic acids such as maleic acid, fumaric acid, itaconic acid and citraconic acid. 1,2,4-benzenetricarboxylic acid, 1,2,5-benzenetricarboxylic acid, anhydrides thereof or lower alkyl esters thereof. These may be used alone or two or more thereof may be used in combination.

Examples of polyhydric alcohols include the following:
Alkylene glycol (ethylene glycol, 1,2-propylene glycol and 1,3-propylene glycol); alkylene ether glycol (polyethylene glycol and polypropylene glycol); alicyclic diol (1,4-cyclohexanedimethanol); bisphenol (bisphenol A); alkylene oxides of alicyclic diols (ethylene oxide and propylene oxide) adducts. The alkyl moieties of alkylene glycol and alkylene ether glycol may be linear or branched. In addition, glycerin, trimethylolethane, trimethylolpropane, pentaerythritol and the like. These may be used alone or two or more thereof may be used in combination.

Here, in order to adjust the acid value and the hydroxyl value, as necessary, monovalent acids such as acetic acid and benzoic acid, and monovalent alcohols such as cyclohexanol and benzyl alcohol can also be used.

As the method of producing a polyester resin, for example, a transesterification method and a direct polycondensation method can be used alone or in combination.

The toner particle may have a core-shell structure including a core particle comprising a resin and a shell that covers the core particle. In consideration of charge stability, the resin forming the shell is preferably a vinyl resin or a polyester resin. An amorphous polyester resin is more preferable. The shell does not necessarily cover the entire core, and some part of the core may be exposed. As the vinyl resin and polyester resin constituting the shell, vinyl resins and polyester resins which can be used for the above crystalline vinyl resin and amorphous resin can be used.

The toner particle may comprise a wax. The wax is at least one selected from the group consisting of a hydrocarbon wax and an ester wax. When a hydrocarbon wax and/or an ester wax is used, it is easier to secure an effective release property.

Examples of hydrocarbon waxes include the following:
Aliphatic hydrocarbon waxes: low-molecular-weight polyethylene, low-molecular-weight polypropylene, low-molecular-weight olefin copolymers, Fischer-Tropsch wax, and waxes obtained by oxidizing or adding acids to these waxes.

The ester wax may be any wax having at least one ester bond in one molecule, and either a natural ester wax or a synthetic ester wax may also be used.

Examples of ester waxes include the following:
Esters of monohydric alcohols and monocarboxylic acids such as behenyl behenate, stearyl stearate, and palmityl palmitate;
Esters of divalent carboxylic acids and monoalcohols such as dibehenyl sebacate;
Esters of divalent alcohols and monocarboxylic acids such as ethylene glycol distearate and hexanediol dibehenate;
Esters of trihydric alcohols and monocarboxylic acids such as glycerin tribehenate;
Esters of tetrahydric alcohols and monocarboxylic acids such as pentaerythritol tetrastearate, and pentaerythritol tetrapalmitate;
Esters of hexahydric alcohols and monocarboxylic acids such as dipentaerythritol hexastearate, dipentaerythritol hexapalmitate, and dipentaerythritol hexabehenate;
Esters of polyfunctional alcohols and monocarboxylic acids such as polyglycerin behenate; and natural ester waxes such as carnauba wax and rice wax.

Among these, an ester wax with two or more functional groups is preferable. That is, the toner particle preferably comprise an ester wax with two or more functional groups.

Particularly, an ester wax which is an ester of a from tetra- to octa valent alcohol and an aliphatic monocarboxylic acid or an ester wax which is an ester of a from tetra- to octa valent carboxylic acid or an aliphatic monoalcohol is more preferable.

When the toner particle comprise these ester waxes, the compatibility with the crystalline vinyl resin during fixing is reduced, and thus it is easier to improve a release property during fixing at low temperatures and to improve the low-temperature fixability. In addition, when the content of the monomer unit (a) in the resin component is appropriately controlled, since it is easier to partially form a eutectic state, peak splitting in differential scanning calorimetric measurement is likely to occur, and the bending resistance is further improved.

In addition, it is still more preferable to use the following ester waxes:
Esters of tetrahydric alcohols and monocarboxylic acids such as pentaerythritol tetrastearate, pentaerythritol tetrapalmitate, and pentaerythritol tetrabehenate, esters of hexahydric alcohols and monocarboxylic acids such as dipentaerythritol hexastearate, dipentaerythritol hexapalmitate, and dipentaerythritol hexabehenate, and esters of octahydric alcohols and monocarboxylic acids such as tripentaerythritol octastearate, tripentaerythritol octapalmitate, and tripentaerythritol octabehenate.

The content of the wax in the toner particle is preferably 1.0 to 30.0 mass %, and more preferably 2.0 to 25.0 mass %. When the content of the wax in the toner particle is within the above range, it is easier to secure a release property during fixing.

The melting point of the wax is preferably 60 to 120° C. When the melting point of the wax is within the above range, the wax melts during fixing and easily exudes onto the surface of the toner particle, and the release property of the wax is easily exhibited. The melting point of the wax is more preferably 70 to 100° C.

The toner particle may comprise a colorant. Examples of colorants include known organic pigments, organic dyes, inorganic pigments, carbon black as a black colorant, and magnetic particles. Other colorants that are conventionally used in toners may also be used.

Examples of yellow colorants include the following: Condensed azo compounds, isoindolinone compounds, anthraquinone compounds, azo metal complexes, methine compounds, and arylamide compounds. Among these, C.I. Pigment yellow 12, 13, 14, 15, 17, 62, 74, 83, 93, 94, 95, 109, 110, 111, 128, 129, 147, 155, 168, and 180 are preferably used.

Examples of magenta colorants include the following. Condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Among these, C.I. Pigment red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Examples of cyan colorants include the following. Copper phthalocyanine compound and their derivatives, anthraquinone compounds, and basic dye lake compounds. Among these, C.I. Pigment blue 1, 7, 15, 15:1, 15:2, 15:3, 15:4, 60, 62, and 66 are preferably used.

The colorant is selected in consideration of the hue angle, chroma, lightness, lightfastness, OHP transparency, and dispersibility in the toner.

The content of the colorant in the toner particle is preferably 1.0 to 20.0 mass %. When magnetic particles are used as the colorant, the content thereof based on the mass of the toner particle is preferably 30.0 to 60.0 mass %.

The toner particle may comprise a charge control agent. In addition, the charge control agent may be externally added to the toner particle. When the charge control agent is used, charging characteristics can be stabilized, and an optimal triboelectric charge quantity can be controlled according to the development system.

As the charge control agent, a charge control agent which exhibits a high charging speed and can stably maintain a certain charge quantity is preferable.

Examples of charge control agents that control the toner to be negatively charged include the following: Organometallic compounds and chelate compounds are effective, and examples thereof include monoazo metallic compounds, acetylacetone metallic compounds, and aromatic oxycarboxylic acid-based, aromatic dicarboxylic acid-based, oxycarboxylic acid-based and dicarboxylic acid-based metallic compounds.

Examples of charge control agents that control the toner to be positively charged include the following: nigrosine, quaternary ammonium salts, metal salts of higher fatty acids, diorganotin borates, guanidine compounds, and imidazole compounds.

The content of the charge control agent in the toner particle is preferably 0.01 to 20.0 mass %, and more preferably 0.5 to 10.0 mass %.

The toner particle may be directly used as a toner, or may be used as a toner after an external additive or the like is mixed as necessary, and adhered to the surface of the toner particle.

Examples of external additives include inorganic fine particles selected from the group consisting of silica fine particles, alumina fine particles, and titania fine particles or complex oxides thereof. Examples of complex oxides include silica aluminum fine particles and strontium titanate fine particles.

The content of the external additive with respect to 100 parts by mass of the toner particles is preferably 0.01 to 8.0 parts by mass and more preferably 0.1 to 4.0 parts by mass.

Toner particle can be produced by methods such as a suspension polymerization method, an emulsion aggregation method, a dissolution suspension method, and a pulverization method. Toner particle is preferably produced by a suspension polymerization method.

Hereinafter, the suspension polymerization method will be described in detail.

For example, a crystalline vinyl resin synthesized in advance is added to a mixture of polymerizable monomers that produce a resin component such as an amorphous resin. As necessary, other materials such as a colorant, a wax, and a charge control agent are added, uniformly dissolved, or dispersed to prepare a polymerizable monomer composition.

Then, the polymerizable monomer composition is dispersed in an aqueous medium using a stirrer or the like to prepare suspended particles of the polymerizable monomer composition. Then, the polymerizable monomers comprised in the particles are polymerized using an initiator or the like, and the obtained toner particle-dispersed solution is cooled to obtain a toner particle-dispersed solution.

The degree of crystallinity of the crystalline vinyl resin can be controlled by the difference in ramp down rate after polymerization. When the ramp down rate is high, the molecular motion stops before the alkyl groups in the side chain of the crystalline resin are regularly aligned, and the degree of crystallinity decreases.

The ramp down rate is preferably appropriately adjusted depending on the type of monomer units to be polymerized. For example, when vinyl polymerization is performed using the (meth)acrylic acid ester having an alkyl group as a polymerizable monomer, the ramp down rate after the polymerization is completed is preferably in the range of 0.030 to 2.500° C./s. The ramp down rate is more preferably 0.050 to 2.000° C./s and still more preferably 0.070 to 1.000° C./s.

After the above cooling, as necessary, an annealing step in which the toner particle-dispersed solution is left at a certain temperature may be performed. When the annealing step is sufficiently performed, it is possible to promote the molecular motion of unaligned polymers and progress crystallization.

In the annealing step, the temperature at which the toner particle-dispersed solution is left is preferably appropriately adjusted depending on the type of monomer units to be polymerized. For example, when vinyl polymerization is performed using the (meth)acrylic acid ester having an alkyl group as a polymerizable monomer, the retention temperature is preferably 30 to 60° C., more preferably 35 to 55° C., and still more preferably 40 to 50° C. In addition, the retention time is preferably 0.5 to 15.0 hours, more preferably 3.0 to 10.0 hours, and still more preferably 5.0 to 10.0 hours.

After the polymerization is completed, the toner particle is filtered, washed, and dried, and as necessary, an external additive can be added to obtain a toner.

That is, the toner production method preferably includes a step of obtaining a polymerizable monomer composition comprising a crystalline vinyl resin, an amorphous resin and as necessary, a colorant, a wax and the like, a step of dispersing the polymerizable monomer composition in an aqueous medium and polymerizing it to obtain a toner particle-dispersed solution, a step of cooling the toner particle-dispersed solution at a ramp down rate of 0.030 to 2.500° C./s, and an annealing step in which the cooled toner particle-dispersed solution is kept at 30 to 60° C. for 30 minutes or longer.

When the crystalline vinyl resin is a vinyl resin, it can be produced using the above monomer units and a polymerization initiator. Examples of polymerization initiators include the following:
Azo-based or diazo-based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide-based polymerization initiators such as benzoyl peroxide, t-butyl peroxy 2-ethylhexanoate, t-butyl peroxypivalate, t-butyl peroxyisobutyrate, t-butyl peroxyoctoate, t-butyl peroxyneodecanoate, methyl ethyl ketone peroxide, diisopropyl peroxydicarbonate, cumene hydroperoxide, 2,4-dichlorobenzoyl peroxide, and lauroyl peroxide.

Among the above examples, the polymerization initiators which are likely to cause a hydrogen abstraction reaction are peroxide-based polymerization initiators, and are preferably used. Among these, initiators such as t-butyl peroxy 2-ethylhexanoate, t-butyl peroxypivalate, t-butyl peroxyisobutyrate, t-butyl peroxyoctoate, and t-butyl peroxyneodecanoate are more preferably used.

In addition, known chain transfer agents and polymerization inhibitors may also be used.

The aqueous medium may comprise an inorganic or organic dispersion stabilizer. As the dispersion stabilizer, known dispersion stabilizers can be used.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Examples of organic dispersion stabilizers include polyvinyl alcohol, gelatin, methyl cellulose, hydroxypropyl methylcellulose, ethyl cellulose, sodium salts of carboxymethylcellulose, polyacrylic acid and its salts, and starch.

When an inorganic compound is used as a dispersion stabilizer, a commercially available product may be used without change, but in order to obtain finer particles, the inorganic compound that is produced in an aqueous medium may also be used.

For example, in the case of calcium phosphate such as hydroxyapatite or tricalcium phosphate, a phosphate aqueous solution and a calcium salt aqueous solution may be mixed under high-speed stirring.

The aqueous medium may comprise a surfactant. As the surfactant, known surfactants can be used. Examples thereof include anionic surfactants such as sodium dodecylbenzene sulfate and sodium oleate; cationic surfactants; amphoteric surfactants; and nonionic surfactants.

In addition, the toner particle may be produced by a pulverization method. For example, a crystalline vinyl resin synthesized in advance is mixed with a resin component such as an amorphous resin and as necessary, a colorant, a mold release agent and the like, and the mixture is melt-kneaded. The obtained melt-kneaded product is cooled and then pulverized, and as necessary, subjected to processing such as classification, and thereby toner particle can be obtained. Here, for melt-kneading and pulverizing, known devices can be used.

That is, the toner production method may include a step of melt-kneading raw materials comprising a crystalline vinyl resin, an amorphous resin and as necessary, a colorant, a wax and the like, and a step of pulverizing the obtained melt-kneaded product to obtain toner particle.

In the case of the melt-kneading method, in order to satisfy all of Formula (1) to Formula (3), for example, the following methods may be exemplified. For example, when the types of crystalline vinyl resins used and the addition amounts of materials other than the binder resin, such as a wax, are controlled as described above, a toner that satisfies all of Formula (1) to Formula (3) can be obtained. Examples of other methods include a method of controlling the ramp down rate after the melt-kneaded product is obtained in the toner particle producing step to be within the above range. In addition, in the same manner as when a toner is produced by a suspension polymerization method, an annealing treatment may be performed after the cooling, and a method of controlling the annealing retention temperature and time to be within the above ranges may be exemplified.

The calculation methods and measurement methods for various physical properties of toners and toner materials will be described below.

Separation of Toner Particle from Toner

The toner particle obtained by separating the toner particle and the external additive by the following method can be used for each analysis.

A total of 160 g of sucrose (manufactured by Kishida Chemical Co., Ltd.) is added to 100 mL of ion-exchanged water and dissolved in a water bath to prepare a sucrose aqueous solution. A total of 31 g of the sucrose aqueous solution and 6 mL of Contaminone N (10% by mass aqueous solution of a neutral detergent for cleaning precision measuring instruments that is composed of a nonionic surfactant, an anionic surfactant, and an organic builder and has pH 7, manufactured by Fujifilm Wako Pure Chemical Industries, Ltd.) are placed in a centrifuge tube to prepare a dispersion liquid. To this dispersion liquid, 1 g of toner is added, and toner lumps are loosened with a spatula or the like.

The centrifuge tube is set in “KM Shaker” (model: V.SX, manufactured by Iwaki Sangyo Co., Ltd.) and shaken for 20 min under the condition of 350 reciprocations per min. After shaking, the solution is transferred to a glass tube (50 mL) for a swing rotor, and centrifugation is performed under the conditions of 3500 rpm and 30 min with a centrifuge.

Toner particle exists in the uppermost layer in a glass tube after centrifugation, and external additives such as fine silica particles exist in the aqueous solution side in the lower layer.

The toner particle on the upper layer is collected, filtered, and washed by flushing them with 2 L of deionized water heated to 40° C., and the washed toner particle is removed.

Method of Measuring Endothermic Peak Temperature and Endothermic Quantity

The endothermic peak temperature (melting point) and the endothermic quantity of the toner, resin or wax are measured using DSC Q2000 (commercially available from TA Instruments) under the following conditions.
Ramp rate: 10° C./min
Measurement onset temperature: 20° C.
Measurement end temperature: 180° C.

The melting points of indium and zinc are used to correct the temperature of a device detection unit, and the heat of fusion of indium is used to correct the amount of heat. Specifically, 5 mg of a sample is accurately weighed out, and placed on an aluminum pan, and differential scanning calorimetric measurement is performed. As a reference, an empty silver pan is used.

The sample is heated from 20° C. to 180° C. at a rate of 10° C./min, and a DSC endothermic curve in the heating process 1 is obtained. Then, after the sample is left at 180° C. for 10 minutes, it is cooled from 180° C. to 20° C. at 10° C./min. In addition, after the sample is left at 20° C. for 10 minutes, the sample is heated again from 20° C. to 180° C. at a rate of 10° C./min, and a DSC endothermic curve in the heating process 2 is obtained. The temperature indicating a minimum value on a differential curve of the obtained DSC endothermic curve is set as a peak top temperature, and the peak top temperature and the endothermic quantity of each endothermic peak are calculated.

The peak top temperature and the endothermic quantity of each endothermic peak are calculated using DSC endothermic curve analysis software “Universal Analysis 2000” (commercially available from TA Instruments).

In calculating the endothermic quantity, a line from the point where the differential value of the lowest-temperature side endothermic peak reaches 0 at or below the endothermic onset temperature to the point where the differential value of the highest-temperature side endothermic peak reaches 0 at or above the endothermic end temperature is set as a baseline.

When the toner comprises a material such as a wax, which has a melting point, other than the crystalline resin, the “endothermic peak derived from the crystalline vinyl resin” in the present disclosure is an endothermic peak obtained by measuring the endothermic peak position of the corresponding material alone and excluding the endothermic peak derived from the melting point of the corresponding material alone. In addition, an endothermic peak derived from a eutectic state of a crystalline vinyl resin and other materials is also defined as an “endothermic peak derived from the crystalline vinyl resin.”

In addition, for measurement accuracy, when a stable DSC endothermic curve cannot be obtained, small peaks resulting from device fluctuations will be excluded when the number of endothermic peaks is counted in the present disclosure. When it is difficult to determine whether it is a phenomenon related to measurement accuracy, peaks with an endothermic quantity of 0.1 J/g or more will be included when the number of endothermic peaks is counted in the present disclosure.

In the heating process 1, a gentle peak derived from the relaxation of the crystalline vinyl resin may appear on the DSC endothermic curve. In this case, by comparing it with a DSC endothermic curve in the heating process 2 in which the peak derived from the relaxation disappears, the peak derived from the relaxation is determined and excluded when the number of endothermic peaks is counted.

When endothermic peaks derived from the crystalline vinyl resins partially overlap, the peaks are divided using the DSC endothermic curve analysis software and each endothermic quantity is then calculated. During division, in the DSC endothermic curve between the peak tops of the overlapping endothermic peaks, a vertical division is made from the point of the maximum value toward the baseline.

In DSC measurement using a toner as a sample, when the endothermic peak derived from the crystalline vinyl resin does not overlap other endothermic peaks such as those of the wax, the obtained endothermic peak is regarded as the “endothermic peak derived from the crystalline vinyl resin” without change.

On the other hand, when the endothermic peaks of other components such as the wax overlap the endothermic peak derived from the crystalline vinyl resin, it is necessary to separate the endothermic peaks derived from the wax and the like. For example, by the following method, the endothermic peak derived from the wax can be separated to obtain the endothermic peak derived from the crystalline vinyl resin.

First, the wax alone is separately subjected to DSC measurement using the above method to determine endothermic characteristics. Next, the wax content in the toner is determined. The wax content in the toner can be measured by known structural analysis. Then, the endothermic peak due to the wax is determined from the wax content in the toner, and by subtracting this portion from the peak derived from the crystalline vinyl resin, the endothermic peak derived from the crystalline vinyl resin can be identified.

### Method of Separating Crystalline Vinyl Resin From Toner Particle

The crystalline vinyl resin can be separated from the toner by known methods. An example is shown below.

As a method of separating the resin component from the toner, a gradient polymer LC is used. This analysis allows separation according to the polarity of the resin in the binder resin, regardless of the molecular weight.

First, the toner is dissolved in chloroform. A sample is prepared in chloroform at a sample concentration of 0.1 mass %, and the solution is filtered through a 0.45 μm PTFE filter, which is then subjected to measurement.

The gradient polymer LC measurement conditions are as follows.
Device: UlTIMATE3000 (commercially available from Thermo Fisher Scientific)
Mobile phase: A chloroform (HPLC), B acetonitrile (HPLC)
Gradient: 2 min (A/B=0/100)→25 min (A/B=100/0)
(where the gradient of the change in the mobile phase is linear.)
Flow rate: 1.0 mL/min
Injection: 0.1 mass %×20 μL
Column: Tosoh TSKgel ODS (4.6 mmψ×150 mm×5 μm)
Column temperature: 40° C.
Detector: Corona charged aerosol detector (Corona-CAD) (commercially available from Thermo Fisher Scientific)

In a time-intensity graph obtained from the above measurement, the resin component can be separated into two peaks depending on the polarity. Then, the above measurement is performed again, and the resin component can be separated into two types of resins by performing isolation when each peak reaches the valley. The separated resins are subjected to DSC measurement, and the resin with a melting point peak is determined to be a crystalline resin.

Here, when the toner comprises wax, it is necessary to separate the wax from the toner. For wax separation, a component with a molecular weight of 2,000 or less is separated as the wax using recycling HPLC. The measurement method is as follows.

First, a toner chloroform solution is prepared by the above method. Then, the obtained solution is filtered through a solvent-resistant membrane filter with a pore diameter of 0.2 μm, “Maishori Disc” (commercially available from Tosoh Corporation) to obtain a sample solution. Here, the sample solution is adjusted so that the concentration of components soluble in chloroform is 1.0 mass %.

The sample solution is used for measurement under the following conditions.
Device: LC-Sakura NEXT (commercially available from Japan Analytical Industry Co., Ltd.)
Column: JAIGEL2H, 4H (commercially available from Japan Analytical Industry Co., Ltd.)
Eluent: chloroform
Flow rate: 10.0 mL/min
Oven temperature: 40.0° C.
Sample injection amount: 1.0 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000, A-500”, by Tosoh Corporation).

From the molecular weight curve thus obtained, a component with a molecular weight of 2,000 or less is repeatedly separated, and the wax is removed from the toner.

Method of Measuring Chain Length of Alkyl Group of Monomer Unit in Crystalline Vinyl Resin

The chain length of the monomer unit in the crystalline vinyl resin is measured by ¹H-NMR under the following conditions. As a measurement sample, the crystalline vinyl resin separated by the above method can be used.
Measurement device: FT NMR device JNM-EX400 (commercially available from JEOL Ltd.)
Measurement frequency: 400 MHz
Pulse condition: 5.0 s
Frequency range: 10,500 Hz
Cumulative number of measurements: 64
Measurement temperature: 30° C.
Sample: 50 mg of the measurement sample is put into a sample tube with an inner diameter of 5 mm, deuterated chloroform (CDCl₃) is added as a solvent, and the sample is dissolved in a thermostatic chamber at 40° C. for preparation.

The obtained ¹H-NMR chart is analyzed, and the structure of each monomer unit is identified. The chain length (number of carbon atoms m) of the alkyl group of the monomer unit can be calculated from the integral ratio of proton peaks in the ¹H-NMR chart.

Here, when a polymerizable monomer that does not comprise hydrogen atoms in the components other than the vinyl group is used, the measurement nucleus is set to ¹³C using ¹³C-NMR, measurement is performed in a single pulse mode, and calculation is performed in the same manner using ¹H-NMR. In addition, the measurement results of infrared absorption spectrum (IR) and gas chromatography-mass spectrometry (GC-MS) may also be used as necessary.

### Method of Measuring Content of Crystalline Vinyl Resin in Resin Component

In the above method of separating the crystalline vinyl resin from the toner particle, the content of the crystalline vinyl resin in the toner is calculated on the basis of the mass of the toner before being dissolved in chloroform and the mass of the crystalline vinyl resin separated from the toner particle.

### Method of Measuring Content of Monomer Unit (a) in Resin Component

The content of the monomer unit (a) in the resin component is measured by ¹H-NMR under the following conditions.
Measurement device: FT NMR device JNM-EX400 (commercially available from JEOL Ltd.)
Measurement frequency: 400 MHz
Pulse condition: 5.0 s
Frequency range: 10,500 Hz
Cumulative number of measurements: 64
Measurement temperature: 30° C.
Sample: prepared as follows.

50 mg of the measurement sample is put into a sample tube with an inner diameter of 5 mm, deuterated chloroform (CDCl₃) is added as a solvent, and the sample is dissolved in a thermostatic chamber at 40° C. for preparation.

As a measurement sample, the crystalline vinyl resin separated from the toner particle using the above method can be used.

The obtained ¹H-NMR chart is analyzed, and the structure of each unit is identified.

In the obtained ¹H-NMR chart, among the peaks attributed to components of the monomer unit (a), a peak independent of peaks attributed to components of other units is selected, and the integral value S1 of this peak is calculated. The integral values of the other units comprised in the resin are calculated in the same manner.

When the units constituting the resin component are the monomer unit (a) and one other unit, the content of the monomer unit (a) is determined using the integral value S1 and the integral value S2 of the peak of the other unit as follows. Here, n1 and n2 are the numbers of hydrogen atoms in the components to which the peak of interest for each site belongs.

The content of the monomer unit (a)

(mol %)={(S1/n1)/((S1/n1)+(S2/n2))}×100

When there are two or more types of other units, the content of the monomer unit (a) can be calculated in the same manner (using S3 . . . Sx, n3 . . . nx).

When a monomer that does not comprise hydrogen atoms in the components other than the vinyl group is used, the measurement nucleus is set to ¹³C using ¹³C-NMR, measurement is performed in a single pulse mode, and calculation is performed in the same manner using ¹H-NMR. The proportion (mol %) of each unit calculated by the above method is multiplied by the molecular weight of each unit to convert the content of each unit into mass %.

In addition, when NMR is measured using a toner as a sample, the peaks of resins other than the wax and the crystalline vinyl resin overlap, and no independent peaks are observed in some cases. Accordingly, the content of each monomer unit in the crystalline vinyl resin cannot be calculated in some cases. In this case, a resin A′ can be produced by performing the same production without using the wax or other resins, and this resin can be analyzed as a crystalline vinyl resin.

### Method of Measuring Weight-Average Molecular Weight (Mw) of Resin

The weight-average molecular weight (Mw) of the resin is measured by gel permeation chromatography (GPC) as follows. Firstly, a sample is dissolved in tetrahydrofuran (THF) at room temperature over 24 hours. The obtained solution is then filtered through a solvent-resistant membrane filter “MYSYORI DISC” (by Tosoh Corporation) having a pore diameter of 0.2 μm, to yield a sample solution. The sample solution is adjusted so that the concentration of the THF-soluble component is 0.8 mass %. This sample solution is used for measurement, under the conditions below.
Apparatus: HLC8120 GPC (detector: RI) (by Tosoh Corporation)
Column: 7 columns Shodex KF-801, 802, 803, 804, 805, 806, 807 (by Showa Denko)
Eluent: tetrahydrofuran (THF)
Flow rate: 1.0 mL/min
Oven temperature: 40.0° C.
Sample injection amount: 0.10 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000, A-500”, by Tosoh Corporation).

### EXAMPLES

The following provides a detailed explanation of the present disclosure through Examples, but the present disclosure is not limited to the following explanation. In the following text of the examples, “parts” is on a mass basis unless specifically indicated otherwise.

### Preparation of Resin A1

The following materials were put into a reaction container including a reflux cooling tube, a stirrer, a thermometer, and a nitrogen inlet tube under a nitrogen atmosphere.
100.0 parts of toluene
100.0 parts of a monomer composition

(The monomer composition used was a mixture of the following monomers in the following proportions.)
(60.0 parts of behenyl acrylate)
(25.0 parts of styrene)
(5.0 parts of methacrylonitrile)
(10.0 parts of N-vinyl-2-pyrrolidone)
2.0 parts by mass of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain a resin A1.

When the resin A1 was analyzed by NMR using the above method and the calculated proportion (mol %) of each unit was converted to mass %, the resin A1 comprised 60.0 mass % of monomer units polymerized from behenyl acrylate, 25.0 mass % of monomer units polymerized from styrene, 5.0 mass % of monomer units polymerized from methacrylonitrile, and 10.0 mass % of monomer units polymerized from N-vinyl-2-pyrrolidone.

### Preparation of Resin B1

The following materials were put into a reaction container including a reflux cooling tube, a stirrer, a thermometer, and a nitrogen inlet tube under a nitrogen atmosphere.
100.0 parts of toluene
100.0 parts of behenyl acrylate
2.0 parts by mass of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain a resin B1.

When the resin B1 was analyzed by NMR using the above method and the calculated proportion (mol %) of each unit was converted to mass %, the resin B1 comprised 100.0 mass % of monomer units polymerized from behenyl acrylate.

### Preparation of Resin C1

The following materials were put into an autoclave including a pressure reducing device, a water separating device, a nitrogen gas inlet device, a temperature measurement device, and a stirring device.
25.3 parts of terephthalic acid
74.7 parts of bisphenol A-propylene oxide 2 mol adduct
0.02 parts of potassium titanium oxalate (catalyst)

Subsequently, the reaction was caused under a nitrogen atmosphere and under atmospheric pressure at 220° C. for 5 hours, and under a reduced pressure of 220° C. for 3 hours. After cooling, the mixture was pulverized to obtain a resin C1.

### Preparation of Resins A2 to A20

Crystalline resins A2 to A20 were prepared in the same manner as in the preparation of the resin A1 except that the type and addition amount of monomers used were changed as shown in Table 1. When the resins A2 to A20 were analyzed by NMR using the above method, the monomer units formed by polymerizing respective monomers were comprised in the same proportion as the monomers used.

### Preparation of Resins B2 to B10

Crystalline resins B2 to B10 were prepared in the same manner as in the preparation of the resin B1 except that the type and addition amount of monomers used, and the addition amount of the polymerization initiator were changed as shown in Table 2.

When the resins B2 to B10 were analyzed by NMR using the above method, the monomer units formed by polymerizing respective monomers were comprised in the same proportion as the monomers used.

TABLE 1

| | Monomer | | | | | | | | | |
|---|---|---|---|---|---|---|---|---|---|---|
| | | Number | | | | | | | | |
| | | of | | Other monomer 1 | | Other monomer 2 | | Other monomer 3 | | |
| | | carbon | Addition | | Addition | | Addition | | Addition | |
| | | atoms | amount | | amount | | amount | | amount | |
| Resin A | Type | m | (parts) | Type | (parts) | Type | (parts) | Type | (parts) | Mw |
| Resin A1 | Behenyl acrylate | 21 | 60.0 | Styrene | 25.0 | Methacrylonitrile | 5.0 | N-vinyl-2-pyrrolidone | 10.0 | 17200 |
| Resin A2 | Behenyl acrylate | 21 | 60.0 | Styrene | 30.0 | Methacrylonitrile | 10.0 | — | — | 17400 |
| Resin A3 | Behenyl acrylate | 21 | 60.0 | Styrene | 15.0 | Methacrylonitrile | 15.0 | N-vinyl-2-pyrrolidone | 10.0 | 18000 |
| Resin A4 | Behenyl acrylate | 21 | 60.0 | Styrene | 27.0 | Methacrylonitrile | 3.0 | N-vinyl-2-pyrrolidone | 10.0 | 18800 |
| Resin A5 | Behenyl acrylate | 21 | 60.0 | Styrene | 29.0 | Methacrylonitrile | 1.0 | N-vinyl-2-pyrrolidone | 10.0 | 18800 |
| Resin A6 | Behenyl acrylate | 21 | 60.0 | Styrene | 26.0 | Methacrylonitrile | 4.0 | N-vinyl-2-pyrrolidone | 10.0 | 18300 |
| Resin A7 | Myricyl acrylate | 29 | 29.4 | Styrene | 25.0 | Methacrylonitrile | 5.0 | N-vinyl-2-pyrrolidone | 10.0 | 17700 |
| | Behenyl acrylate | 21 | 30.6 | | | | | | | |
| Resin A8 | Myricyl acrylate | 29 | 31.2 | Styrene | 25.0 | Methacrylonitrile | 5.0 | N-vinyl-2-pyrrolidone | 10.0 | 17800 |
| | Behenyl acrylate | 21 | 28.8 | | | | | | | |
| Resin A9 | Stearyl acrylate | 17 | 32.5 | Styrene | 25.0 | Methacrylonitrile | 5.0 | N-vinyl-2-pyrrolidone | 10.0 | 16000 |
| | Behenyl acrylate | 21 | 27.5 | | | | | | | |
| Resin A10 | Stearyl acrylate | 17 | 37.5 | Styrene | 25.0 | Methacrylonitrile | 5.0 | N-vinyl-2-pyrrolidone | 10.0 | 15700 |
| | Behenyl acrylate | 21 | 22.5 | | | | | | | |
| Resin A11 | Stearyl acrylate | 17 | 25.0 | Styrene | 25.0 | Methacrylonitrile | 5.0 | N-vinyl-2-pyrrolidone | 10.0 | 16300 |
| | Behenyl acrylate | 21 | 35.0 | | | | | | | |
| Resin A12 | Stearyl acrylate | 17 | 30.0 | Styrene | 25.0 | Methacrylonifrile | 5.0 | N-vinyl-2-pyrrolidone | 10.0 | 16100 |
| | Behenyl acrylate | 21 | 30.0 | | | | | | | |
| Resin A13 | Stearyl acrylate | 17 | 22.5 | Styrene | 25.0 | Methacrylonitrile | 5.0 | N-vinyl-2-pyrrolidone | 10.0 | 16500 |
| | Behenyl acrylate | 21 | 37.5 | | | | | | | |
| Resin A14 | Stearyl acrylate | 17 | 22.0 | Styrene | 25.0 | Methacrylonitrile | 5.0 | N-vinyl-2-pyrrolidone | 10.0 | 16500 |
| | Behenyl acrylate | 21 | 38.0 | | | | | | | |
| Resin A15 | Behenyl acrylate | 21 | 66.0 | Styrene | 18.0 | Methacrylonitrile | 6.0 | N-vinyl-2-pyrrolidone | 10.0 | 17800 |
| Resin A16 | Behenyl acrylate | 21 | 70.0 | Styrene | 15.0 | Methecrylonitrile | 5.0 | N-vinyl-2-pyrrolidone | 10.0 | 18000 |
| Resin A17 | Behenyl acrylate | 21 | 54.0 | Styrene | 27.0 | Methacrylonitrile | 9.0 | N-vinyl-2-pyrrolidone | 10.0 | 17000 |
| Resin A18 | Behenyl acrylate | 21 | 50.0 | Styrene | 30.0 | Methacrylonitrile | 10.0 | N-vinyl-2-pyrrolidone | 10.0 | 16800 |
| Resin A19 | Behenyl acrylate | 21 | 60.0 | Styrene | 31.5 | Methacrylonitrile | 0.5 | N-vinyl-2-pyrrolidone | 10.0 | 19000 |
| Resin A20 | Behenyl acrylate | 21 | 60.0 | Styrene | 34.5 | Methacrylonitrile | 0.5 | N-vinyl-2-pyrrolidone | 5.0 | 19300 |

In the table, Mw is the weight-average molecular weight (Mw) of a tetrahydrofuran (THF)-soluble component measured by gel permeation chromatography (GPC).

TABLE 2

| | | | | | | | | Polymerization | |
|---|---|---|---|---|---|---|---|---|---|
| | Monomer | | | Other monomer 1 | | Other monomer 2 | | initiator | |
| | | Number | Addition | | Addition | | Addition | Addition | |
| | | of carbon | amount | | amount | | amount | amount | |
| Resin B | Type | atoms m | (parts) | Type | (parts) | Type | (parts) | (parts) | Mw |
| Resin B1 | Behenyl acrylate | 21 | 100.0 | — | — | — | — | 2.0 | 12000 |
| Resin B2 | Myricyl acrylate | 29 | 59.3 | — | — | — | — | 2.0 | 13200 |
| | Behenyl acrylate | 21 | 40.7 | | | | | | |
| Resin B3 | Myricyl acrylate | 29 | 62.4 | — | — | — | — | 2.0 | 13300 |
| | Behenyl acrylate | 21 | 37.6 | | | | | | |
| Resin B4 | Stearyl acrylate | 17 | 16.2 | — | — | — | — | 2.0 | 10900 |
| | Behenyl acrylate | 21 | 83.8 | | | | | | |
| Resin B5 | Myricyl acrylate | 29 | 30.2 | — | — | — | — | 2.0 | 12500 |
| | Behenyl acrylate | 21 | 69.8 | | | | | | |
| Resin B6 | Myricyl acrylate | 29 | 46.8 | — | — | — | — | 2.0 | 12800 |
| | Behenyl acrylate | 21 | 53.2 | | | | | | |
| Resin B7 | Behenyl acrylate | 21 | 100.0 | — | — | — | — | 2.5 | 10100 |
| Resin B8 | Behenyl acrylate | 21 | 100.0 | — | — | — | — | 3.0 | 9200 |
| Resin B9 | Behenyl acrylate | 21 | 88.0 | Styrene | 10.0 | Methacrylonitrile | 2.0 | 2.0 | 11500 |
| Resin B10 | Behenyl acrylate | 21 | 80.0 | Styrene | 16.7 | Methacrylonitrile | 3.3 | 2.0 | 11300 |

### Example 1

### Production of Toner by Suspension Polymerization Method

### Production of Toner Particle 1

A mixture including the following materials was prepared.
45.0 parts of styrene
15.0 parts of n-butyl acrylate
6.5 parts of pigment blue 15: 3 (colorant)

The mixture was put into an attritor (commercially available from Nippon Coke & Engineering. Co., Ltd.), and dispersion was performed using zirconia beads with a diameter of 5 mm at 200 rpm for 2 hours to obtain a raw material-dispersed solution.

On the other hand, 735.0 parts of deionized water and 16.0 parts of trisodium phosphate (12-hydrate) were put into a container including a high-speed stirring device Homomixer (commercially available from Primix Corporation) and a thermometer, and heated to 60° C. with stirring at 12,000 rpm. A calcium chloride aqueous solution in which 9.0 parts of calcium chloride (dihydrate) was dissolved in 65.0 parts of deionized water was added thereto, and while maintaining the temperature at 60° C., the mixture was stirred at 12,000 rpm for 30 minutes. 10% hydrochloric acid was added thereto to adjust the pH to 6.0, and thereby an aqueous medium in which an inorganic dispersion stabilizer comprising hydroxyapatite was dispersed in water was obtained.

Subsequently, the raw material-dispersed solution was transferred to a container including a stirring device and a thermometer, and heated to 60° C. with stirring at 100 rpm. The following materials were added thereto, and the mixture was stirred at 100 rpm for 30 minutes while maintaining the temperature at 60° C.
30.0 parts of the resin A1
10.0 parts of the resin B1
4.0 parts of the resin C1
9.0 parts of DP18 (dipentaerythritol stearate wax, a melting point of 79° C., commercially available from The Nisshin OilliO Group, Ltd.)
0.1 parts of HDDA (hexanediol diacrylate)

Then, 8.0 parts of t-butyl peroxypivalate (PERBUTYL PV, commercially available from NOF Corporation) as a polymerization initiator was added and the mixture was stirred for another 1 minute, and then added to an aqueous medium that was stirred at 12,000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 75° C. under a nitrogen atmosphere with stirring at 150 rpm. While maintaining the temperature at 75° C., a polymerization reaction was performed at 150 rpm for 6 hours to obtain a toner particle-dispersed solution.

The obtained toner particle-dispersed solution was cooled to 48° C. at a ramp down rate of 0.083° C./s with stirring at 150 rpm, and an annealing treatment was then performed for 8 hours while maintaining the temperature at 48° C. Then, while maintaining stirring, dilute hydrochloric acid was added until the pH reached 1.5 to dissolve the dispersion stabilizer. The solid content was filtered off, sufficiently washed with deionized water and then vacuum-dried at 30° C. for 24 hours to obtain toner particle 1.

### Preparation of Toner 1

2.0 parts of silica fine particles (hydrophobized with hexamethyldisilazane, the number-average particle diameter of primary particles: 10 nm, BET specific surface area: 170 m²/g) as an external additive were added to 98.0 parts of the toner particle 1, and the mixture was mixed in a Henschel mixer (commercially available from Nippon Coke & Engineering. Co., Ltd.) at 3,000 rpm for 15 minutes to obtain a toner 1 comprising the resin A1 and the resin B1. Table 4 shows the physical properties and the like of the obtained toner 1, and Table 5 shows the evaluation results.

### Examples 2 to 29

Toner particles 2 to 29 were obtained in the same manner as in Example 1 except that the type and addition amount of resins used, the type and addition amount of waxes, the ramp down rate after polymerization, the annealing temperature, and the annealing time were changed as shown in Tables 3-1 and 3-2.

In addition, external addition was performed in the same manner as in Example 1 to obtain toners 2 to 29. Table 4 shows the physical properties of the toners, and Table 5 shows the evaluation results.

### Example 30

### Production of Toner by Pulverization Method

### Preparation of Amorphous Vinyl Resin 1

The following materials were put into a reaction container including a reflux cooling tube, a stirrer, a thermometer, and a nitrogen inlet tube under a nitrogen atmosphere.
100.0 parts of a solvent (toluene)
45.0 parts of styrene
15.0 parts of n-butyl acrylate
0.1 parts of HDDA (hexanediol diacrylate)
5.0 parts of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain an amorphous vinyl resin 1.

When the amorphous vinyl resin 1 was analyzed by NMR using the above method and mol % was converted to mass %, the monomer units formed by polymerizing respective monomers were comprised in the same proportion as the monomers used.

### Production of Toner Particle 30

Amorphous vinyl resin 1: 60.0 parts
Resin A1: 30.0 parts
Resin B1: 10.0 parts
Resin C1: 4.0 parts
DP18 (dipentaerythritol stearate wax, a melting point of 79° C., commercially available from The Nisshin OilliO Group, Ltd.): 9.0 parts
Pigment blue 15: 3 (colorant): 6.5 parts

The above materials were mixed in a Henschel mixer (model FM-75, commercially available from Mitsui Mining Co., Ltd.) at a rotational speed of 1,500 rpm for a rotation time of 5 min, and then kneaded in a twin-screw kneader (model PCM-30, commercially available from Ikegai) set to a temperature of 130° C. The obtained kneaded product was cooled and coarsely pulverized to 1 mm or less using a hammer mill to obtain a crushed product.

The obtained crushed product was finely pulverized using a mechanical pulverizer (T-250, commercially available from Turbo Industry Co., Ltd.). In addition, classification was performed using Faculty (F-300, commercially available from Hosokawa Micron Corporation) to obtain toner particle 30. The operation conditions were a classifying rotor rotational speed of 11,000 rpm and a dispersing rotor rotational speed of 7,200 rpm.

### Production of Toner 30

External addition was performed on the toner particle 30 in the same manner as in Example 1 to obtain a toner 30. Table 4 shows the physical properties of the toners, and Table 5 shows the evaluation results.

### Comparative Examples 1 to 4

Comparative toner particles 1 to 4 were obtained in the same manner as in Example 1 except that the type and addition amount of resins used, the type and addition amount of waxes, the ramp down rate after polymerization, the annealing temperature, and the annealing time were changed as shown in Tables 3-1 and 3-2.

In addition, external addition was performed in the same manner as in Example 1 to obtain comparative toners 1 to 4. Table 4 shows the physical properties of the toners, and Table 5 shows the evaluation results.

### Comparative Example 5

### Preparation of Comparative Amorphous Vinyl Resin 1

The following materials were put into a reaction container including a reflux cooling tube, a stirrer, a thermometer, and a nitrogen inlet tube under a nitrogen atmosphere.
100.0 parts of a solvent (toluene)
64.0 parts of styrene
28.0 parts of behenyl acrylate
5.0 parts of acrylonitrile
3.0 parts of methacrylic acid
5.0 parts of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain comparative amorphous vinyl resin 1.

When the comparative amorphous vinyl resin 1 was analyzed by NMR using the above method and mol % was converted to mass %, the comparative amorphous vinyl resin 1 comprised 64.0 mass % of monomer units polymerized from styrene, 28.0 mass % of monomer units polymerized from behenyl acrylate, 5.0 mass % of monomer units polymerized from acrylonitrile, and 3.0 mass % of monomer units polymerized from methacrylic acid.

### Production Example of Comparative Toner 5

### Production of Toner by Suspension Polymerization Method

### Preparation of Comparative Toner Particle 5

The following materials were put into an attritor (commercially available from Nippon Coke & Engineering. Co., Ltd.).
28.9 parts of methacrylonitrile
6.7 parts of styrene
12.5 parts of ethyl methacrylate
6.0 parts of colorant pigment blue 15:3

Dispersion was performed using zirconia beads with a diameter of 5 mm at 200 rpm for 2 hours to obtain a raw material-dispersed solution.

On the other hand, 735.0 parts of deionized water and 16.0 parts of trisodium phosphate/dodecahydrate were put into a container including a high-speed stirring device Homomixer (commercially available from Primix Corporation) and a thermometer, and heated to 60° C. with stirring at 12,000 rpm. Subsequently, a calcium chloride aqueous solution in which 9.0 parts of calcium chloride/dihydrate was dissolved in 65.0 parts of deionized water was put into the container, and while maintaining the temperature at 60° C., the mixture was stirred at 12,000 rpm for 30 minutes to obtain an aqueous medium in which a dispersion stabilizer comprising hydroxyapatite was dispersed in water.

Subsequently, the raw material-dispersed solution was transferred to a container including a stirring device and a thermometer, and heated to 60° C. with stirring at 100 rpm. The following materials were added thereto.
48.1 parts of behenyl acrylate
3.8 parts of the comparative amorphous vinyl resin 1
9.0 parts of DP18 (dipentaerythritol stearate wax, a melting point of 79° C., commercially available from The Nisshin OilliO Group, Ltd.)

While maintaining the temperature at 60° C., the mixture was stirred at 100 rpm for 30 minutes, 4.5 parts of t-butyl peroxypivalate (PERBUTYL PV, commercially available from NOF Corporation) as a polymerization initiator was then added, and the mixture was stirred for another minute and added to an aqueous medium that was stirred at 12,000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 70° C. under a nitrogen atmosphere with stirring at 150 rpm. While maintaining the temperature at 70° C., a polymerization reaction was performed at 150 rpm for 12 hours to obtain a toner particle-dispersed solution. The obtained toner particle-dispersed solution was cooled to 48° C. at a ramp down rate of 0.083° C./s with stirring at 150 rpm, and an annealing treatment was then performed for 8 hours while maintaining the temperature at 48° C.

After the annealing treatment, the temperature was lowered to 30° C., and while maintaining stirring, dilute hydrochloric acid was added until the pH reached 1.5 to dissolve the dispersion stabilizer. Then, the solid content was filtered off, sufficiently washed with deionized water, and then vacuum-dried at 30° C. for 24 hours to obtain comparative toner particle 5 comprising the comparative amorphous vinyl resin 1.

In addition, a resin A1′ was obtained in the same production method of the comparative toner particle 5 except that no pigment blue 15: 3, and wax were used. When the resin A1′ was analyzed by NMR, and mol % was converted to mass %, the resin A1′ comprised 48.1 mass % of monomer units polymerized from behenyl acrylate, 28.9 mass % of monomer units polymerized from methacrylonitrile, 6.7 mass % of monomer units polymerized from styrene, and 12.5 mass % of monomer units polymerized from ethyl methacrylate.

2.0 parts of silica fine particles (dimethyl silicone treatment, the number-average particle diameter of primary particles: 10 nm) as an external additive were added to 100.0 parts of the comparative toner particle 5, and the mixture was mixed using an FM mixer (commercially available from Nippon Coke & Engineering. Co., Ltd.) at 3,000 rpm for 15 minutes to obtain a comparative toner 5.

### Comparative Example 6

### Production of Toner by Pulverization Method

### Preparation of Comparative Crystalline Vinyl Resin 1

Solvent: 100.0 parts of toluene
100.0 parts of a monomer composition

(The monomer composition used was a mixture of the following polymerizable monomers in the following proportions.)
(92.0 parts of behenyl acrylate (first polymerizable monomer))
(7.0 parts of acrylonitrile (second polymerizable monomer))
(1.0 part of styrene (third polymerizable monomer))
1.0 part of polymerization initiator t-butyl peroxypivalate (PERBUTYL PV, commercially available from NOF Corporation)

The above materials were put into a reaction container including a reflux cooling tube, a stirrer, a thermometer, and a nitrogen inlet tube under a nitrogen atmosphere.

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain comparative crystalline vinyl resin 1.

When the comparative crystalline vinyl resin 1 was analyzed by NMR using the above method, and mol % was converted to mass %, the comparative crystalline vinyl resin 1 comprised 92.0 mass % of monomer units polymerized from behenyl acrylate, 7.0 mass % of monomer units polymerized from acrylonitrile, and 1.0 mass % of monomer units polymerized from styrene.

### Preparation of Comparative Crystalline Polyester Resin 1

1,3-propanediol: 34.5 parts
Malonic acid: 65.5 parts
Tin 2-ethylhexanoate: 0.5 parts

The above materials were weighed out in a reaction chamber including a cooling tube, a stirrer, a nitrogen inlet tube, and a thermocouple. The inside of the flask was replaced with nitrogen gas, the temperature was then gradually raised with stirring, and the reaction was caused for 3 hours while stirring at a temperature of 140° C. Next, the pressure in the reaction chamber was lowered to 8.3 kPa, and the reaction was caused for 4 hours while maintaining the temperature at 200° C.

Then, the pressure of the reaction chamber was reduced to 5 kPa or less, the reaction was caused at 200° C. for 3 hours, and thereby a comparative crystalline polyester resin 1 was obtained.

### Preparation of Comparative Amorphous Polyester Resin 1

Bisphenol A/propylene oxide adduct (an average number of moles added of 2.0): 36.0 parts
Ethylene glycol: 14.0 parts
Terephthalic acid: 50.0 parts
Titanium tetrabutoxide (esterification catalyst): 0.5 parts

The above materials were weighed out in a reaction chamber including a cooling tube, a stirrer, a nitrogen inlet tube, and a thermocouple. Next, the inside of the flask was replaced with nitrogen gas, the temperature was then gradually raised with stirring, and the reaction was caused for 2 hours while stirring at a temperature of 200° C.

In addition, the pressure in the reaction chamber was lowered to 8.3 kPa, the reaction was caused for 5 hours while maintaining the temperature at 200° C., and after it was confirmed that the softening point measured according to ASTM D36-86 reached a temperature of 100° C., the temperature was lowered to stop the reaction, and thereby a comparative amorphous polyester resin 1 was obtained.
Production of Comparative Toner particle 6
Comparative amorphous polyester resin 1: 100 parts
Comparative crystalline polyester resin 1: 50.0 parts
Comparative crystalline vinyl resin 1: 70.0 parts
Fischer-Tropsch wax (a peak temperature 90° C. of the maximum endothermic peak): 5.0 parts
Carbon black: 10 parts

The above materials were mixed in a Henschel mixer (model FM-75, commercially available from Mitsui Mining Co., Ltd.) at a rotational speed of 1,500 rpm for a rotation time of 5 min, and then kneaded in a twin-screw kneader (model PCM-30, commercially available from Ikegai) set to a temperature of 130° C. The obtained kneaded product was cooled and coarsely pulverized to 1 mm or less using a hammer mill to obtain a crushed product.

The obtained crushed product was finely pulverized using a mechanical pulverizer (T-250, commercially available from Turbo Industry Co., Ltd.). In addition, classification was performed using Faculty (F-300, commercially available from Hosokawa Micron Corporation) to obtain comparative toner particle 6. The operation conditions were a classifying rotor rotational speed of 11,000 rpm and a dispersing rotor rotational speed of 7,200 rpm.

### Production of Comparative Toner 6

Comparative toner particle 6: 100 parts
Hydrophobic silica fine particles (BET: 200 m²/g): 1.0 part
Titanium oxide fine particles whose surfaces were treated with isobutyltrimethoxysilane (BET: 80 m²/g): 1.0 part

The above materials were mixed in a Henschel mixer (model FM-75, commercially available from Mitsui Miike Machinery Co., Ltd.) at a rotational speed of 1,900 rpm for a rotation time of 10 min to obtain a comparative toner 6.

### Comparative Example 7

### Production of Toner by Dissolution Suspension Method

Preparation of Comparative Amorphous Polyester Resin 2
Bisphenol A ethylene oxide 2 mol adduct: 119 parts
Bisphenol A propylene oxide 3 mol adduct: 300 parts
Terephthalic acid: 90 parts
Adipic acid: 200 parts
Dibutyltin oxide: 1 part

The above materials were put into a reaction container including a cooling tube, a stirrer and a nitrogen inlet tube, reacted at 230° C. for 8 hours under atmospheric pressure, and additionally reacted under a reduced pressure of 10 to 15 mmHg for 5 hours. Then, 22 parts of trimellitic anhydride was put into the reaction container and the mixture was reacted at 180° C. under atmospheric pressure for 2 hours. The obtained resin was pulverized using a jet pulverizer (IDS: commercially available from Nippon Pneumatic Mfg. Co., Ltd.) until the volume average particle diameter reached 30 μm, 300 parts of ethanol was added to 100 parts by mass of the pulverized resin and mixed for 2 hours to obtain a comparative amorphous polyester resin 2.

### Preparation of Comparative Amorphous Polyester Resin 3

Bisphenol A ethylene oxide 2 mol adduct: 264 parts
Bisphenol A propylene oxide 2 mol adduct: 520 parts
Terephthalic acid: 123 parts
Adipic acid: 173 parts
Dibutyltin oxide: 1 part

The above materials were put into a reaction container including a cooling tube, a stirrer and a nitrogen inlet tube, reacted at 230° C. for 8 hours under atmospheric pressure, and additionally reacted under a reduced pressure of 10 to 15 mmHg for 8 hours. Then, 26 parts of trimellitic anhydride was put into the reaction container and the mixture was reacted at 180° C. under atmospheric pressure for 2 hours. The obtained resin was pulverized in the same manner as in the comparative amorphous polyester resin 2 and treated with ethanol to obtain a comparative amorphous polyester resin 3.

### Comparative Crystalline Polyester Resin 2

1,6-hexanediol: 500 parts
Succinic acid: 550 parts
Dibutyltin oxide: 2.5 parts

The above materials were put into a reaction container including a cooling tube, a stirrer and a nitrogen inlet tube and reacted under atmospheric pressure at 200° C. for 8 hours and additionally reacted under a reduced pressure of 10 to 15 mmHg for 2 hours to obtain a comparative crystalline polyester resin 2. The obtained comparative crystalline polyester resin 2 was pulverized in the same manner as in the comparative amorphous polyester resin 2 and treated with ethanol to obtain a comparative crystalline polyester resin 2.

### Synthesis of Prepolymer

Into a reaction container including a cooling tube, a stirrer and a nitrogen inlet tube, 1,2-propylene glycol: 366 parts, terephthalic acid: 566 parts, trimellitic anhydride: 44 parts and titanium tetrabutoxide: 6 parts were put, and reacted under atmospheric pressure at 230° C. for 8 hours, and additionally reacted under a reduced pressure of 10 to 15 mmHg for 5 hours to obtain an intermediate polyester 1.

Next, into a reaction container including a cooling tube, a stirrer and a nitrogen inlet tube, the intermediate polyester 1: 420 parts, isophorone diisocyanate: 80 parts, and ethyl acetate: 500 parts were put, and reacted at 100° C. for 5 hours to obtain a prepolymer.

### Crystalline Resin-Dispersed Solution 1

The following materials were put into a 5 L metal container, heated and dissolved at 75° C., and then rapidly cooled in an ice bath at a rate of 27° C./min.
Comparative crystalline polyester resin 2: 100 parts
Comparative amorphous polyester resin 3: 100 parts
Ethyl acetate: 400 parts

500 mL of glass beads (3 mmφ) was added thereto, and pulverizing was performed using a batch type sand mill device (commercially available from Kanpe Hapio Co., Ltd.) for 36 hours to obtain a crystalline resin-dispersed solution 1.

### Preparation of Masterbatch

Carbon black (REGAL 400R, commercially available from Carbot): 40 parts, the comparative amorphous polyester resin 3 as a binder resin: 60 parts, and water: 30 parts were mixed in a Henschel mixer to obtain a mixture in which water penetrated into pigment aggregates. This mixture was kneaded for 45 minutes using two rollers with a roller surface temperature set to 130° C., and pulverized in a pulverizer to a size of 1 mmφ to obtain a masterbatch 1.

### Production of Comparative Toner Particle 7

### Preparation of Oil Phase

Amorphous polyester resin 2: 100 parts
Crystalline resin-dispersed solution 1: 34.5 parts
Paraffin wax (HNP51 (commercially available from Nippon Seiro Co., Ltd.)): 10 parts
Ethyl acetate: 96 parts

The above materials were put into a container including a stirring rod and a thermometer, heated to 80° C. with stirring, and left 5 hours at 80° C., and then cooled to 30° C. over 1 hour. Next, 11 parts of the masterbatch 1 were added and mixed for 1 hour, the mixture was then transferred into another container, and dispersed using a bead mill (Ultra visco mill, commercially available from IMEX Co., Ltd.) under conditions of a liquid delivery rate of 1 kg/hr, a disk circumferential speed of 6 m/see, 80 vol % filling of 0.5 mm zirconia beads, and 3 passes. Next, 30 parts of the prepolymer was added, and the mixture was stirred with a three-one motor for 2 hours to obtain an oil phase 1.

### Preparation of Aqueous Phase

Deionized water: 472 parts, a 50% aqueous solution of sodium dodecyl diphenyl ether disulfonate (ELEMINOL MON-7: commercially available from Sanyo Chemical Industries, Ltd.): 81 parts, a 1% aqueous solution of carboxymethylcellulose as a viscosity improver: 67 parts, and ethyl acetate: 54 parts were mixed and stirred to obtain an aqueous phase 1, which was a milky white liquid.

### Emulsifying Step

The total amount of the oil phase 1 was mixed in a TK homomixer (commercially available from Tokushu Kika Kogyo Co., Ltd.) at 5,000 rpm for 1 minute, 321 parts of the aqueous phase 1 were then added thereto and mixed in the TK homomixer for 20 minutes while adjusting the rotational speed to 8,000 to 13,000 rpm, and thereby a slurry 1 was obtained.

### Desolvation Agent

The slurry 1 was put into a container including a stirrer and a thermometer, and the solvent was removed at 30° C. for 8 hours to obtain a dispersion slurry 1.

### Washing→Drying

(1): 100 parts of the dispersion slurry 1 were filtered under a reduced pressure, 100 parts of deionized water were then added to the filter cake, and mixed in a TK homomixer (at a rotational speed of 12,000 rpm for 10 minutes), and the mixture was then filtered.
(2): 100 parts of deionized water were added to the filter cake of (1) and mixed in the TK homomixer by applying ultrasonic vibrations (at a rotational speed of 12,000 rpm for 30 minutes), and the mixture was then filtered under a reduced pressure. This operation was repeated until the electrical conductivity of the reslurry solution reached 10 S/cm or less.
(3): 10% hydrochloric acid was added to the reslurry solution of (2) so that the pH was 4, and the mixture was directly stirred with a three-one motor and filtered after 30 minutes.
(4): 100 parts of deionized water were added to the filter cake of (3) and mixed in the TK homomixer (at a rotational speed of 12,000 rpm for 10 minutes), and the mixture was then filtered. This operation was repeated until the electrical conductivity of the reslurry solution reached 10 S/cm or less, and thereby a filter cake 1 was obtained. The remaining dispersion slurry 1 was also washed in the same manner and added and mixed as the filter cake 1.
(5): The filter cake 1 was dried using a circulating air dryer at 45° C. for 48 hours and sieved through a mesh with an opening of 75 μm to obtain comparative toner particle 7.

### Production of Comparative Toner 7

To Comparative toner 7: 50 parts, 1 part of hydrophobic silica particles with a primary particle diameter of 30 nm, and 0.5 parts of hydrophobic silica particles with a primary particle diameter of 10 nm were added, and mixed in a Henschel mixer to obtain a comparative toner 7.

Table 4 shows the physical properties and the like of the obtained comparative toners 5 to 7, and Table 5 shows the evaluation results.

TABLE 3-1

| | | | Binder resin | | | | | | | | | | |
|---|---|---|---|---|---|---|---|---|---|---|---|---|---|
| | | | | | | | Mass | | | | | | |
| | | | | | | | proportion of | | | Polymerizable | | Polymerizable | |
| | | | Resin A | | Resin B | | crystalline vinyl | Resin C | | monomer 1 | | monomer 2 | |
| | | | | Addition | | Addition | resin in resin | | Addition | | Addition | | Addition |
| | Toner | Production | | amount | | amount | component | | amount | | amount | | amount |
| | No. | method | Type | (parts) | Type | (parts) | (wt. %) | Type | (parts) | Type | (parts) | Type | (parts) |
| Example 1 | 1 | A | A1 | 30.0 | B1 | 10.0 | 38.5 | C1 | 4.0 | Styrene | 45.0 | n-BA | 15.0 |
| Example 2 | 2 | A | A2 | 30.0 | B1 | 10.0 | 38.5 | C1 | 4.0 | Styrene | 42.0 | n-BA | 18.0 |
| Example 3 | 3 | A | A3 | 30.0 | B1 | 10.0 | 38.5 | C1 | 4.0 | Styrene | 48.0 | n-BA | 12.0 |
| Example 4 | 4 | A | A4 | 30.0 | B1 | 10.0 | 38.5 | C1 | 4.0 | Styrene | 45.0 | n-BA | 15.0 |
| Example 5 | 5 | A | A5 | 30.0 | B1 | 10.0 | 38.5 | C1 | 4.0 | Styrene | 45.0 | n-BA | 15.0 |
| Example 6 | 6 | A | A6 | 30.0 | B1 | 10.0 | 38.5 | C1 | 4.0 | Styrene | 45.0 | n-BA | 15.0 |
| Example 7 | 7 | A | A1 | 30.0 | B1 | 10.0 | 38.5 | C1 | 4.0 | Styrene | 45.0 | n-BA | 15.0 |
| Example 8 | 8 | A | A7 | 30.0 | B2 | 10.0 | 38.5 | C1 | 4.0 | Styrene | 45.0 | n-BA | 15.0 |
| Example 9 | 9 | A | A8 | 30.0 | B3 | 10.0 | 38.5 | C1 | 4.0 | Styrene | 45.0 | n-BA | 15.0 |
| Example 10 | 10 | A | A9 | 30.0 | B4 | 10.0 | 38.5 | C1 | 4.0 | Styrene | 45.0 | n-BA | 15.0 |
| Example 11 | 11 | A | A10 | 30.0 | B4 | 10.0 | 38.5 | C1 | 4.0 | Styrene | 45.0 | n-BA | 15.0 |
| Example 12 | 12 | A | A11 | 30.0 | B1 | 10.0 | 38.5 | C1 | 4.0 | Styrene | 45.0 | n-BA | 15.0 |
| Example 13 | 13 | A | A12 | 30.0 | B1 | 10.0 | 38.5 | C1 | 4.0 | Styrene | 45.0 | n-BA | 15.0 |
| Example 14 | 14 | A | A13 | 30.0 | B5 | 10.0 | 38.5 | C1 | 4.0 | Styrene | 45.0 | n-BA | 15.0 |
| Example 15 | 15 | A | A14 | 30.0 | B6 | 10.0 | 38.5 | C1 | 4.0 | Styrene | 45.0 | n-BA | 15.0 |
| Example 16 | 16 | A | A1 | 30.0 | B7 | 10.0 | 38.5 | C1 | 4.0 | Styrene | 45.0 | n-BA | 15.0 |
| Example 17 | 17 | A | A1 | 30.0 | B8 | 10.0 | 38.5 | C1 | 4.0 | Styrene | 45.0 | n-BA | 15.0 |
| Example 18 | 18 | A | A1 | 53.0 | B1 | 10.0 | 60.6 | C1 | 4.0 | Styrene | 27.8 | n-BA | 9.3 |
| Example 19 | 19 | A | A1 | 21.2 | B1 | 10.0 | 30.0 | C1 | 4.0 | Styrene | 51.6 | n-BA | 17.2 |
| Example 20 | 20 | A | A1 | 19.0 | B1 | 10.0 | 27.9 | C1 | 4.0 | Styrene | 53.3 | n-BA | 17.8 |
| Example 21 | 21 | A | A15 | 30.0 | B1 | 10.0 | 38.5 | C1 | 4.0 | Styrene | 45.0 | n-BA | 15.0 |
| Example 22 | 22 | A | A16 | 30.0 | B1 | 10.0 | 38.5 | C1 | 4.0 | Styrene | 45.0 | n-BA | 15.0 |
| Example 23 | 23 | A | A17 | 30.0 | B1 | 10.0 | 38.5 | C1 | 4.0 | Styrene | 45.0 | n-BA | 15.0 |
| Example 24 | 24 | A | A18 | 30.0 | B1 | 10.0 | 38.5 | C1 | 4.0 | Styrene | 45.0 | n-BA | 15.0 |
| Example 25 | 25 | A | A1 | 30.0 | B9 | 10.0 | 38.5 | C1 | 4.0 | Styrene | 45.0 | n-BA | 15.0 |
| Example 26 | 26 | A | A18 | 30.0 | B9 | 10.0 | 38.5 | C1 | 4.0 | Styrene | 45.0 | n-BA | 15.0 |
| Example 27 | 27 | A | A16 | 30.0 | B10 | 10.0 | 38.5 | C1 | 4.0 | Styrene | 45.0 | n-BA | 15.0 |
| Example 28 | 28 | A | A1 | 30.0 | B10 | 10.0 | 38.5 | C1 | 4.0 | Styrene | 45.0 | n-BA | 15.0 |
| Example 29 | 29 | A | A1 | 30.0 | B1 | 10.0 | 38.5 | C1 | 4.0 | Styrene | 45.0 | n-BA | 15.0 |
| Example 30 | 30 | B | A1 | 30.0 | B1 | 10.0 | 38.5 | C1 | 4.0 | Styrene | 45.0 | n-BA | 15.0 |
| Comparative | C. 1 | A | A1 | 40.0 | — | 10.0 | 48.1 | C1 | 4.0 | Styrene | 37.5 | n-BA | 12.5 |
| Example 1 | | | | | | | | | | | | | |
| Comparative | C. 2 | A | A19 | 30.0 | B1 | 10.0 | 38.5 | C1 | 4.0 | Styrene | 45.0 | n-BA | 15.0 |
| Example 2 | | | | | | | | | | | | | |
| Comparative | C. 3 | A | A20 | 30.0 | B1 | 10.0 | 38.5 | C1 | 4.0 | Styrene | 45.0 | n-BA | 15.0 |
| Example 3 | | | | | | | | | | | | | |
| Comparative | C. 4 | A | A1 | 30.0 | B1 | 10.0 | 38.5 | C1 | 4.0 | Styrene | 45.0 | n-BA | 15.0 |
| Example 4 | | | | | | | | | | | | | |
| Comparative | C. 5 | A | Described in the specification | | | | | | | | | | |
| Example 5 | | | | | | | | | | | | | |
| Comparative | C. 6 | B | Described in the specification | | | | | | | | | | |
| Example 6 | | | | | | | | | | | | | |
| Comparative | C. 7 | C | Described in the specification | | | | | | | | | | |
| Example 7 | | | | | | | | | | | | | |

In Table 3-1, production method A indicates suspension polymerization method, production method B indicates pulverization method, production method C indicates dissolution suspension method, and “n-BA” indicates n-butyl acrylate, respectively. The description such as “C.1” indicates “Comparative 1”.

TABLE 3-2

| | | | | Cooling rate | | |
|---|---|---|---|---|---|---|
| | | Wax | | after | | |
| | | | Addition | polymerization | Annealing | Annealing |
| | Toner | | amount | is completed | temperature | time |
| | No. | Type | (parts) | (° C./s) | (° C.) | (hr) |
| Example 1 | 1 | Dipentaerythritol stearate wax | 9.0 | 0.083 | 48 | 8.0 |
| Example 2 | 2 | Dipentaerythritol stearate wax | 9.0 | 0.083 | 48 | 8.0 |
| Example 3 | 3 | Dipentaerythritol stearate wax | 11.0 | 2.000 | 48 | 1.0 |
| Example 4 | 4 | Dipentaerythritol stearate wax | 7.0 | 0.040 | 48 | 10.0 |
| Example 5 | 5 | Dipentaerythritol stearate wax | 9.0 | 0.083 | 48 | 8.0 |
| Example 6 | 6 | Dipentaerythritol stearate wax | 9.0 | 0.083 | 48 | 8.0 |
| Example 7 | 7 | Dipentaerythritol stearate wax | 6.5 | 0.083 | 48 | 8.0 |
| Example 8 | 8 | Dipentaerythritol stearate wax | 9.0 | 0.083 | 67 | 8.0 |
| Example 9 | 9 | Dipentaerythritol stearate wax | 9.0 | 0.083 | 69 | 8.0 |
| Example 10 | 10 | Dipentaerythritol stearate wax | 9.0 | 0.083 | 37 | 8.0 |
| Example 11 | 11 | Dipentaerythritol stearate wax | 9.0 | 0.083 | 35 | 8.0 |
| Example 12 | 12 | Dipentaerythritol stearate wax | 9.0 | 0.083 | 40 | 8.0 |
| Example 13 | 13 | Dipentaerythritol stearate wax | 9.0 | 0.083 | 38 | 8.0 |
| Example 14 | 14 | Dipentaerythritol stearate wax | 9.0 | 0.083 | 42 | 8.0 |
| Example 15 | 15 | Dipentaerythritol stearate wax | 9.0 | 0.083 | 42 | 8.0 |
| Example 16 | 16 | Dipentaerythritol stearate wax | 9.0 | 0.083 | 48 | 8.0 |
| Example 17 | 17 | Dipentaerythritol stearate wax | 9.0 | 0.083 | 48 | 8.0 |
| Example 18 | 18 | Dipentaerythritol stearate wax | 9.0 | 0.083 | 48 | 8.0 |
| Example 19 | 19 | Dipentaerythritol stearate wax | 9.0 | 0.083 | 48 | 8.0 |
| Example 20 | 20 | Dipentaerythritol stearate wax | 9.0 | 0.083 | 48 | 8.0 |
| Example 21 | 21 | Dipentaerythritol stearate wax | 9.0 | 0.083 | 48 | 8.0 |
| Example 22 | 22 | Dipentaerythritol stearate wax | 9.0 | 0.083 | 48 | 8.0 |
| Example 23 | 23 | Dipentaerythritol stearate wax | 9.0 | 0.083 | 48 | 8.0 |
| Example 24 | 24 | Dipentaerythritol stearate wax | 9.0 | 0.083 | 48 | 8.0 |
| Example 25 | 25 | Dipentaerythritol stearate wax | 9.0 | 0.083 | 48 | 8.0 |
| Example 26 | 26 | Dipentaerythritol stearate wax | 9.0 | 0.083 | 48 | 8.0 |
| Example 27 | 27 | Dipentaerythritol stearate wax | 9.0 | 0.083 | 48 | 8.0 |
| Example 28 | 28 | Dipentaerythritol stearate wax | 9.0 | 0.083 | 48 | 8.0 |
| Example 29 | 29 | Paraffin wax (HNP51) | 9.0 | 0.083 | 48 | 8.0 |
| Example 30 | 30 | Dipentaerythritol stearate wax | 9.0 | — | — | — |
| Comparative | Comparative 1 | Dipentaerythritol stearate wax | 9.0 | 0.083 | 48 | 8.0 |
| Example 1 | | | | | | |
| Comparative | Comparative 2 | Dipentaerythritol stearate wax | 9.0 | 0.020 | 48 | 12.0 |
| Example 2 | | | | | | |
| Comparative | Comparative 3 | Dipentaerythritol stearate wax | 9.0 | 0.083 | 48 | 8.0 |
| Example 3 | | | | | | |
| Comparative | Comparative 4 | Dipentaerythritol stearate wax | 6.0 | 0.083 | 48 | 8.0 |
| Example 4 | | | | | | |
| Comparative | Comparative 5 | Dipentaerythritol stearate wax | 9.0 | 0.083 | 48 | 8.0 |
| Example 5 | | | | | | |
| Comparative | Comparative 6 | Fischer-Tropsch wax | 5.0 | — | — | — |
| Example 6 | | | | | | |
| Comparative | Comparative 7 | Paraffin wax (HNP51) | 10.0 | — | — | — |
| Example 7 | | | | | | |

In Table 3-2, the paraffin wax used in the toner 29 and the comparative toner 7 was HNP51 (commercially available from Nippon Seiro Co., Ltd.).

TABLE 4

| | Toner | | | S1 | S21 | S22 | S22 + S22 | | | T1 | T21 | T22 | T22 − T21 |
|---|---|---|---|---|---|---|---|---|---|---|---|---|---|
| | No. | (A) | (B) | (J/g) | (J/g) | (J/g) | (J/g) | S1 × 0.10 | S1 × 0.25 | (° C.) | (° C.) | (° C.) | (° C.) |
| Example 1 | 1 | 1 | 2 | 22.0 | 8.9 | 5.1 | 14.0 | 2.2 | 5.5 | 61.2 | 56.8 | 62.1 | 5.3 |
| Example 2 | 2 | 1 | 2 | 21.8 | 8.5 | 4.8 | 13.3 | 2.2 | 5.5 | 60.8 | 56.8 | 62.0 | 5.2 |
| Example 3 | 3 | 1 | 2 | 22.1 | 12.5 | 7.0 | 19.5 | 2.2 | 5.5 | 61.0 | 56.8 | 62.0 | 5.2 |
| Example 4 | 4 | 1 | 2 | 21.7 | 3.0 | 2.4 | 5.4 | 2.2 | 5.4 | 61.2 | 56.8 | 62.1 | 5.3 |
| Example 5 | 5 | 1 | 2 | 21.8 | 2.2 | 5.0 | 7.2 | 2.2 | 5.5 | 61.3 | 59.0 | 62.1 | 3.1 |
| Example 6 | 6 | 1 | 2 | 21.9 | 5.5 | 5.0 | 10.5 | 2.2 | 5.5 | 61.2 | 57.0 | 62.3 | 5.3 |
| Example 7 | 7 | 1 | 2 | 21.9 | 8.8 | 2.2 | 11.0 | 2.2 | 5.5 | 61.2 | 56.8 | 62.1 | 5.3 |
| Example 8 | 8 | 1 | 2 | 22.0 | 8.9 | 5.0 | 13.9 | 2.2 | 5.5 | 80.0 | 77.0 | 80.3 | 3.3 |
| Example 9 | 9 | 1 | 2 | 22.0 | 8.6 | 4.8 | 13.4 | 2.2 | 5.5 | 82.0 | 78.0 | 81.3 | 3.3 |
| Example 10 | 10 | 1 | 2 | 22.2 | 9.1 | 5.1 | 14.2 | 2.2 | 5.6 | 50.0 | 47.0 | 56.1 | 9.1 |
| Example 11 | 11 | 1 | 2 | 22.1 | 8.8 | 4.9 | 13.7 | 2.2 | 5.5 | 48.0 | 45.0 | 56.1 | 11.1 |
| Example 12 | 12 | 1 | 2 | 22.0 | 8.6 | 4.8 | 13.4 | 2.2 | 5.5 | 53.1 | 50.0 | 62.1 | 12.1 |
| Example 13 | 13 | 1 | 2 | 22.0 | 8.6 | 4.8 | 13.4 | 2.2 | 5.5 | 51.3 | 48.0 | 62.1 | 14.1 |
| Example 14 | 14 | 1 | 2 | 22.1 | 8.8 | 4.9 | 13.7 | 2.2 | 5.5 | 55.0 | 51.0 | 71.0 | 20.0 |
| Example 15 | 15 | 1 | 2 | 22.1 | 8.9 | 5.0 | 13.9 | 2.2 | 5.5 | 55.1 | 51.2 | 76.3 | 25.1 |
| Example 16 | 16 | 1 | 2 | 22.2 | 9.1 | 5.1 | 14.2 | 2.2 | 5.6 | 61.3 | 56.8 | 59.8 | 3.0 |
| Example 17 | 17 | 1 | 2 | 22.1 | 8.9 | 5.0 | 13.9 | 2.2 | 5.5 | 61.2 | 56.7 | 59.1 | 2.4 |
| Example 18 | 18 | 1 | 2 | 22.1 | 12.0 | 6.8 | 18.8 | 2.2 | 5.5 | 61.2 | 56.6 | 61.8 | 5.2 |
| Example 19 | 19 | 1 | 2 | 22.1 | 7.8 | 4.4 | 12.2 | 2.2 | 5.5 | 61.4 | 56.9 | 62.1 | 5.2 |
| Example 20 | 20 | 1 | 2 | 22.2 | 7.4 | 4.1 | 11.5 | 2.2 | 5.6 | 61.4 | 56.7 | 61.8 | 5.1 |
| Example 21 | 21 | 1 | 2 | 22.1 | 8.9 | 5.0 | 13.9 | 2.2 | 5.5 | 61.4 | 57.0 | 62.4 | 5.4 |
| Example 22 | 22 | 1 | 2 | 22.1 | 8.9 | 5.0 | 13.9 | 2.2 | 5.5 | 61.2 | 56.6 | 61.8 | 5.2 |
| Example 23 | 23 | 1 | 2 | 22.2 | 9.1 | 5.1 | 14.2 | 2.2 | 5.6 | 60.8 | 57.0 | 62.4 | 5.4 |
| Example 24 | 24 | 1 | 2 | 22.1 | 8.8 | 4.9 | 13.7 | 2.2 | 5.5 | 60.9 | 57.0 | 62.3 | 5.3 |
| Example 25 | 25 | 1 | 2 | 22.0 | 8.6 | 4.8 | 13.4 | 2.2 | 5.5 | 61.3 | 56.8 | 62.1 | 5.3 |
| Example 26 | 26 | 1 | 2 | 22.3 | 9.3 | 5.2 | 14.5 | 2.2 | 5.6 | 61.2 | 56.8 | 62.2 | 5.4 |
| Example 27 | 27 | 1 | 2 | 22.2 | 9.1 | 5.1 | 14.2 | 2.2 | 5.6 | 61.4 | 56.6 | 61.8 | 5.2 |
| Example 28 | 28 | 1 | 2 | 22.2 | 9.2 | 5.2 | 14.4 | 2.2 | 5.6 | 61.2 | 56.8 | 62.2 | 5.4 |
| Example 29 | 29 | 1 | 2 | 22.1 | 8.9 | 5.0 | 13.9 | 2.2 | 5.5 | 61.2 | 56.8 | 62.1 | 5.3 |
| Example 30 | 30 | 1 | 2 | 22.0 | 9.2 | 5.1 | 14.3 | 2.2 | 5.5 | 61.2 | 56.8 | 62.1 | 5.3 |
| Comparative | Comparative 1 | 1 | 1 | 22.0 | — | — | — | 2.2 | 5.5 | 64.0 | — | — | — |
| Example 1 | | | | | | | | | | | | | |
| Comparative | Comparative 2 | 1 | 2 | 21.7 | 3.2 | 1.8 | 5.0 | 2.2 | 5.4 | 61.2 | 56.8 | 62.1 | 5.3 |
| Example 2 | | | | | | | | | | | | | |
| Comparative | Comparative 3 | 1 | 2 | 21.7 | 1.7 | 5.0 | 6.7 | 2.2 | 5.4 | 61.4 | 58.3 | 63.5 | 5.2 |
| Example 3 | | | | | | | | | | | | | |
| Comparative | Comparative 4 | 1 | 2 | 22.0 | 9.0 | 1.8 | 10.8 | 2.2 | 5.5 | 61.2 | 56.8 | 62.1 | 5.3 |
| Example 4 | | | | | | | | | | | | | |
| Comparative | Comparative 5 | 1 | 1 | 42.7 | — | — | — | 4.3 | 10.7 | 63.2 | — | — | — |
| Example 5 | | | | | | | | | | | | | |
| Comparative | Comparative 6 | 2 | 2 | 2.9 | — | — | — | 0.3 | 0.7 | 65.2 | — | — | — |
| Example 6 | | | | | | | | | | | | | |
| Comparative | Comparative 7 | 1 | 0 | — | — | — | — | — | — | — | — | — | — |
| Example 7 | | | | | | | | | | | | | |

In Table 4, (A) indicates the number of endothermic peaks confirmed in the heating process 1. (B) indicates the number of endothermic peaks confirmed in the heating process 2.

The endothermic peaks confirmed in the heating processes in Examples 1 to 30 and Comparative Examples 1 to 5 were all “endothermic peaks derived from the crystalline vinyl resins” measured by the above method.

In Comparative Example 6, two endothermic peaks were confirmed in each of the heating processes 1 and 2. These peaks were thought to be the peak derived from the crystalline vinyl resin and the endothermic peak derived from the crystalline polyester resin.

In Comparative Example 7, one endothermic peak was confirmed in the heating process 1. This peak was thought to be the endothermic peak derived from the crystalline polyester resin.

### Toner Evaluating Method

The toners of Examples 1 to 30 and Comparative Examples 1 to 7 were subjected to the following evaluations. The evaluation results are shown in Table 5.

### <1> Evaluation of Low-Temperature Fixability

A process cartridge filled with a toner (a process cartridge for a laser beam printer (LBP-712Ci, commercially available from Canon Inc.)) was left at 25° C. and a humidity of 40% RH for 48 hours.

Using a modified machine that was modified on the basis of a laser beam printer (LBP-712Ci, commercially available from Canon Inc.) so that it could operate even if the fixing unit was removed, an unfixed image with an image pattern in which 10 mm×10 mm square images were evenly arranged at 9 points across the entire transfer paper was output. The amount of the toner applied to the transfer paper was 0.80 mg/cm², and the fixing onset temperature was evaluated. Here, the transfer paper used was A4 size paper (prober bond paper: 105 g/m², commercially available from Fox River).

The fixing unit used was an external fixing unit that was modified so that it could operate outside of a laser beam printer by removing the fixing unit of the laser beam printer (LBP-712Ci, commercially available from Canon Inc.) to the outside. Here, the fixation temperature of the external fixing unit was increased in 5° C. increments from 90° C., and fixing was performed under conditions of a process speed: 360 mm/s.

The fixed image was visually checked, the lowest temperature at which no cold offset occurred was set as the fixing onset temperature, and the low-temperature fixability was evaluated.

### <2> Evaluation of Bending Resistance

A printer LBP-712Ci (commercially available from Canon Inc.) was used to evaluate the bending resistance. A process cartridge filled with a toner was left in an environment at 25° C. and a humidity of 40% RH for 48 hours. Using the printer, two sheets of transfer paper with 50 mm×50 mm solid images with a toner laid-on level of 0.8 mg/cm² formed in the center at the fixing onset temperature measured in the above low-temperature fixability evaluation+10° C. were printed.

One of the printed solid images was subjected to the following bending operation.

In the bending operation, the transfer paper was bent so that the valley fold lines drew the diagonal lines of the solid image, and the transfer paper was bent so that the mountain fold lines bisected each side of the transfer image and a cross was drawn at the center of the solid image. That is, after one bending operation, on the solid image, two valley fold lines and two mountain fold lines were formed.

The bending operation was performed five times. That is, after the above bending was performed, the transfer paper was unbent and then bent again at the same position, which was repeated for a total of five bending operations. After the bending operation was completed, the transfer paper was unbent, covered with soft thin paper (product name “Dusper,” commercially available from Ozu Corporation), and rubbed back and forth eight times while applying a load of 4.9 kPa from above the thin paper. The image density was measured using the intersection of four bending lines as the center of the solid image.

One sheet of the printed solid images was not bent but only rubbed, and the image density was measured at the center of the solid image.

The image density was measured using a color reflection densitometer (X-Rite 404A, commercially available from X-Rite). The image densities at the center of the solid images on the transfer paper that had been bent and the transfer paper that had not been bent were compared, and the rate of decrease in image density was evaluated.

Here, the rate of decrease in image density was calculated by the following calculation formula. The smaller value of the rate of decrease in image density, the better the bending resistance.

The rate of decrease in image density (%)={(the image density of the transfer paper that had not been bent)−(the image density of the transfer paper that had been bent)}/(the image density of the transfer paper that had not been bent)×100

### <3> Evaluation of Image Loading Property

Using the LBP-712Ci modified machine, on image receiving paper (Office Planner 64 g/m², commercially available from Canon Inc.), an unfixed toner image (0.6 mg/cm²) with a length of 2.0 cm and a width of 15.0 cm was formed in a part 1.0 cm from the upper end in the paper feed direction. Next, the obtained unfixed image was fixed at a temperature 20° C. higher than the fixing onset temperature measured in the above low-temperature fixability evaluation to obtain fixed image paper.

The obtained fixed image paper was subjected to the following evaluation.

500 sheets of unused paper (Office Planner 64 g/m², commercially available from Canon Inc.) were stacked, and the fixed image paper was placed on the 500th sheet of paper with the image part facing downward so that the image part was in contact with the sheet. In addition, 700 sheets of unused paper of the same type were stacked on the fixed image paper, and the fixed image paper was inserted therebetween. This sample was placed in a thermostatic chamber whose temperature and humidity were controlled to 45° C. and a humidity of 70% RH, left for 72 hours, and then removed from the thermostatic chamber.

Then, the reflectance of the part of the unused paper (the 500th sheet of paper) in contact with the fixed image paper, which was in contact with the image part of the fixed image paper, was measured. The reflectance of the part of the unused paper that was not in contact with the image part was subtracted from the measured reflectance to measure the reflectance of the image whose color was transferred from the fixed image.

The image loading property was evaluated on the basis of the measured reflectance. Here, the reflectance was measured using TC-6DS (commercially available from Tokyo Denshoku Co., Ltd.). The smaller the reflectance value, the better the image loading property.

### <4> Evaluation of Scratch Resistance

A fixed image was printed in the same method as in the above low-temperature fixability evaluation. The fixation temperature was set to a temperature 5° C. higher than the fixing onset temperature measured in the above low-temperature fixability evaluation.

Soft thin paper (Dusper, commercially available from Ozu Corporation) was placed on the image area of the obtained fixed image, and the image area was rubbed back and forth five times while applying a load of 4.9 kPa from above the thin paper. The image density was measured before rubbing and after rubbing, and the rate of decrease in image density ΔD (%) was calculated by the following formula. This ΔD (%) was used as an index of scratch resistance.

ΔD (%)={(the image density before rubbing−the image density after rubbing)/the image density before rubbing}×100

The image density was measured using a color reflection densitometer (X-Rite 404A, commercially available from X-Rite).

The smaller the value ΔD (%), the better the scratch resistance.

### <5> Evaluation of Heat-Resistant Storability

In order to evaluate the stability during storage, the heat-resistant storability was evaluated.

5 g of the toner was placed in a 100 mL resin cup and left in an environment at a temperature of 50° C. and a humidity of 70% RH for 3 days, and the degree of agglomeration of the toner was then measured and evaluated as follows.

As the measurement device, a device obtained by connecting a digital display vibration meter “DIGI-VIBRO MODEL 1332A” (commercially available from Showasokki Co., Ltd.) to a vibration table side part of a “powder tester” (commercially available from Hosokawa Micron Corporation) was used. Then, on the vibration table of the powder tester, a sieve with an opening of 38 μm (400 mesh), a sieve with an opening of 75 μm (200 mesh), and a sieve with an opening of 150 μm (100 mesh) were stacked and set in that order from bottom to top. The measurement was performed in an environment at 23° C. and a humidity of 60% RH as follows.
(1) The vibration amplitude of the vibration table was adjusted in advance so that the displacement value of a digital display vibration meter was 0.60 mm (peak-to-peak).
(2) The toner left for 3 days as described above was left in an environment at 23° C. and a humidity of 60% RH for 24 hours in advance. Then, 5.00 g of the toner was accurately weighed out, and gently placed on the top sieve with an opening of 150 μm.
(3) The sieve was vibrated for 15 seconds, the mass of the toner remaining on each sieve was then measured, and the degree of agglomeration was calculated on the basis of the following formula. The evaluation results are shown in Table 5.

The degree of agglomeration (%)={(the mass (g) of the sample on the sieve with an opening of 150 μm)/5.00 (g)}×100+{(the mass (g) of the sample on the sieve with an opening of 75 μm)/5.00 (g)}×100×0.6+{(the mass (g) of the sample on the sieve with an opening of 38 μm)/5.00 (g)}×100×0.2

The lower the degree of agglomeration (%), the better the heat-resistant storability.

TABLE 5

| | | Low-temperature | Bending | | Scratch | |
|---|---|---|---|---|---|---|
| | | fixability | resistance | Image loading | resistance | Heat-resistant |
| | | cold offset | Rate of | property | Rate of | storability |
| | | Fixing onset | decrease in | Concentration of | decrease in | Degree of |
| | | temperature | image density | color-transferred | image density | agglomeration |
| | Toner | (° C.) | (%) | part (%) | (%) | (%) |
| Example 1 | Toner 1 | 100 | 3.5 | 0.4 | 2.2 | 5 |
| Example 2 | Toner 2 | 100 | 8.0 | 0.7 | 2.9 | 5 |
| Example 3 | Toner 3 | 100 | 9.5 | 0.2 | 2.2 | 5 |
| Example 4 | Toner 4 | 100 | 2.4 | 3.4 | 2.2 | 5 |
| Example 5 | Toner 5 | 100 | 2.6 | 2.8 | 2.2 | 5 |
| Example 6 | Toner 6 | 100 | 2.7 | 2.5 | 2.2 | 5 |
| Example 7 | Toner 7 | 100 | 2.9 | 2.5 | 2.2 | 5 |
| Example 8 | Toner 8 | 115 | 3.5 | 0.3 | 1.3 | 3 |
| Example 9 | Toner 9 | 120 | 3.5 | 0.3 | 1.2 | 3 |
| Example 10 | Toner 10 | 90 | 3.5 | 1.0 | 2.8 | 9 |
| Example 11 | Toner 11 | 90 | 3.5 | 0.8 | 2.9 | 17 |
| Example 12 | Toner 12 | 95 | 3.5 | 0.7 | 8.2 | 5 |
| Example 13 | Toner 13 | 95 | 3.5 | 0.9 | 8.5 | 5 |
| Example 14 | Toner 14 | 100 | 2.6 | 0.6 | 7.3 | 5 |
| Example 15 | Toner 15 | 100 | 2.4 | 0.5 | 7.5 | 5 |
| Example 16 | Toner 16 | 100 | 7.4 | 0.4 | 1.5 | 5 |
| Example 17 | Toner 17 | 100 | 9.8 | 0.4 | 1.4 | 5 |
| Example 18 | Toner 18 | 90 | 9.5 | 0.2 | 2.2 | 5 |
| Example 19 | Toner 19 | 110 | 3.0 | 0.4 | 2.2 | 4 |
| Example 20 | Toner 20 | 105 | 2.8 | 0.4 | 2.2 | 4 |
| Example 21 | Toner 21 | 100 | 4.7 | 0.3 | 2.2 | 5 |
| Example 22 | Toner 22 | 100 | 4.9 | 0.2 | 2.2 | 5 |
| Example 23 | Toner 23 | 100 | 2.9 | 1.6 | 2.2 | 5 |
| Example 24 | Toner 24 | 100 | 2.7 | 1.3 | 2.2 | 5 |
| Example 25 | Toner 25 | 100 | 6.1 | 0.4 | 2.2 | 5 |
| Example 26 | Toner 26 | 105 | 3.5 | 1.7 | 2.2 | 4 |
| Example 27 | Toner 27 | 100 | 8.1 | 0.4 | 2.2 | 5 |
| Example 28 | Toner 28 | 100 | 7.7 | 0.4 | 2.2 | 9 |
| Example 29 | Toner 29 | 100 | 4.3 | 0.4 | 2.2 | 5 |
| Example 30 | Toner 30 | 100 | 3.6 | 0.4 | 2.2 | 5 |
| Comparative | Comparative | 100 | 12.3 | 0.1 | 2.2 | 5 |
| Example 1 | Toner 1 | | | | | |
| Comparative | Comparative | 100 | 2.3 | 4.4 | 2.2 | 5 |
| Example 2 | Toner 2 | | | | | |
| Comparative | Comparative | 100 | 2.5 | 4.2 | 2.2 | 5 |
| Example 3 | Toner 3 | | | | | |
| Comparative | Comparative | 100 | 2.8 | 4.2 | 2.2 | 5 |
| Example 4 | Toner 4 | | | | | |
| Comparative | Comparative | 100 | 7.7 | 4.2 | 1.8 | 5 |
| Example 5 | Toner 5 | | | | | |
| Comparative | Comparative | 135 | 2.5 | 0.4 | 2.5 | 2 |
| Example 6 | Toner 6 | | | | | |
| Comparative | Comparative | 115 | 2.1 | 4.4 | 9.8 | 3 |
| Example 7 | Toner 7 | | | | | |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154655, filed Sep. 9, 2024, which is hereby incorporated by reference herein in its entirety.

What is claimed is:

1. A toner comprising a toner particle comprising a resin component,
wherein the resin component comprises a crystalline vinyl resin,
when a temperature indicating a minimum value on a differential curve of a DSC endothermic curve during heating in differential scanning calorimetric measurement of the toner is defined as a peak top temperature,
in a heating process 1 in which a temperature is raised from 20° C. to 180° C. at a ramp rate of 10° C./min, there is one endothermic peak derived from the crystalline vinyl resin, and
following the heating process 1, in a heating process 2 in which a temperature is lowered from 180° C. to 20° C. at a ramp down rate of 10° C./min, and a temperature is raised again from 20° C. to 180° C. at a ramp rate of 10° C./min, there are two endothermic peaks derived from the crystalline vinyl resin,
when the endothermic peak derived from the crystalline vinyl resin in the heating process 1 is defined as an endothermic peak P1,
in the heating process 2, between the two endothermic peaks derived from the crystalline vinyl resin, a low-temperature side endothermic peak exhibiting the peak top temperature is defined as an endothermic peak P21, a high-temperature side endothermic peak exhibiting the peak top temperature is defined as an endothermic peak P22,
an endothermic quantity of the endothermic peak P1 is defined as S1 (J/g), an endothermic quantity of the endothermic peak P21 is defined as S21 (J/g), and an endothermic quantity of the endothermic peak P22 is defined as S22 (J/g),
the S1, the S21 and the S22 satisfy following Formulas (1) to (3).
S1≥(S21+S22)≥S1×0.25 Formula (1)
S21≥S1×0.10 Formula (2)
S22≥S1×0.10 Formula (3)

2. The toner according to claim 1, wherein, when the peak top temperature of the endothermic peak P1 is defined as T1 (° C.), the T1 is from 50.0 to 80.0° C.

3. The toner according to claim 1, wherein, when the peak top temperature of the endothermic peak P21 is defined as T21 (° C.), the T21 is 45.0° C. or higher.

4. The toner according to claim 1, wherein, when the peak top temperature of the endothermic peak P21 is defined as T21 (° C.), and the peak top temperature of the endothermic peak P22 is defined as T22 (° C.), the T21 and the T22 satisfy following Formula (4).
20.0≥(T22−T21)≥3.0 Formula (4)

5. The toner according to claim 1, wherein the crystalline vinyl resin comprises a monomer unit (a) represented by following Formula (5): 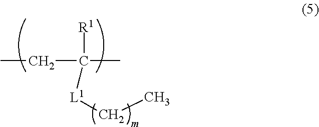
where, in Formula (5), R¹ represents a hydrogen atom or a methyl group, Li represents a single bond, an ester bond or an amide bond, and m represents an integer of 15 to 30.

6. The toner according to claim 1, wherein a mass proportion of the crystalline vinyl resin in the resin component is 30.0 mass % or more.

7. The toner according to claim 5, wherein the crystalline vinyl resin comprises
a crystalline vinyl resin A in which a content of the monomer unit (a) is 50.0 to 70.0 mass %, and
a crystalline vinyl resin B in which a content of the monomer unit (a) is 80.0 to 100.0 mass %.

8. The toner according to claim 1, wherein the toner particle comprises an ester wax with two or more functional groups.
